(19) United States
(12) Patent Application Publication
(10) Pub. No.: US 2006/0274674 A1
(43) Pub. Date: Dec. 7, 2006

(54) Packet transmitting apparatus for setting configuration

(76) Inventors: Hideki Okita, Kokubunji (JP); Toshiaki Suzuki, Hachioji (JP); Kenichi Sakamoto, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/444,456

(22) Filed: Jun. 1, 2006

(30) Foreign Application Priority Data
Jun. 3, 2005 (JP) 2005-163960

(51) Int. Cl. H04L 12/28

(52) U.S. Cl. 370/254

(57) ABSTRACT

Provided is a packet transmitting apparatus included in a network, for transferring a frame in the network, including: a configuration managing module for setting a frame transfer function and a filtering function based on a configuration; a configuration setting module for providing an interface that accepts an instruction regarding the configuration for an administrator; and a configuration transmitting/receiving module for transmitting/receiving the configuration to/from another packet transmitting apparatus, in which the configuration transmitting/receiving module makes a request for the configuration to the another packet transmitting apparatus, receives the configuration from the another packet transmitting apparatus, and updates the configuration of this apparatus based on the received configuration, and the configuration managing module sets a filtering condition of a transfer frame based on the updated configuration.

### CLAIM OF PRIORITY

The present application claims priority from Japanese patent application P2005-163960 filed on Jun. 3, 2005, the content of which is hereby incorporated by reference into this application.

### BACKGROUND OF THE INVENTION

This invention relates to a packet transmitting apparatus for transferring frames and/or packets, in particular, a technique of setting a configuration for defining an operation of the packet transmitting apparatus.

When networking equipment corresponding to a packet transmitting apparatus (such as a router and a switch) is to be operated in a large-scale network in a communication carrier, a company or the like, a network administrator sets, for ensuring security, a switch to filter a packet or a frame which is not necessary for the operation. The network administrator sets the switch to output a log or a load status to a management server in order to monitor an operating status of the switch.

For the above-described reason, when a new switch is to be introduced into the network, a network administrator is required to set an IP address, a host name, and many other items such as a filter rule or a log acquisition item to each piece of equipment prior to a connection to the network.

In particular, when a large number of pieces of equipment are to be simultaneously installed with a large-scale modification of the network, an amount of operation for the setting becomes enormous.

In order to reduce the operation of setting the switch in the network to reduce operation management cost, the related art as described below exists.

A technique of distributing a file which describes a configuration for defining an operation of the switch has been proposed. To be specific, a management server provided in the network retains a file that describes a configuration for each switch. The switch uses a Trivial File Transfer Protocol (TFTP) to obtain the file that describes the configuration from the management server to set a content of the file in the self apparatus.

A technique of automatically setting an IP address of a subscriber host connected to a downstream of the network according to an IP address pool and a channel configuration which are retained by an upstream network has been proposed. To be specific, a Dynamic Host Configuration Protocol (DHCP) is defined by RFC2131 and RFC3315 to realize IP address automatic setting in an IPv4 or IPv6 network. For a DHCPv6, the DHCP is used between an upstream router and a downstream router to realize prefix delegation that delegates a prefix, as described in IETF RFC2131, Dynamic Host Configuration Protocol and IETF RFC3315, Dynamic Host Configuration Protocol for IPv6.

In addition, a technique of allowing the combination of a VLAN ID and a VLAN name to be automatically shared by switches in a layer-2 network to eliminate a need of a setting operation for each of the switches has been proposed. To be specific, a switch has a function of processing a VLAN Trunk Protocol (VTP) described in Understanding and Configuring VLAN Trunk Protocol, Tech Notes, Document ID: 10558, Cisco Systems, Apr. 25, 2005. A switch having the VTP processing function in a layer-2 Ethernet network receives a broadcast message from a VTP server to automatically reflect creation/update information of the VLAN setting in the VTP server.

### SUMMARY OF THE INVENTION

When the switch obtains the configuration file in the TFTP from the management server to apply network operation policy including security setting such as a filter rule, reachability in an IP-layer is required to be established with the management server. The network administrator sets the configuration of the switch in advance to ensure the connection of the switch in the IP-layer.

However, while the configuration on the management server is being reflected on the switch, the security level is temporarily lowered. When the IP address is set for a line interface (or a virtual interface) of the switch, the reachability of an IP packet to IP equipment connected to the switch is established at the same time. Therefore, frame transfer is started even though the security is not set from the management server. Accordingly, until the security is set, there is a possibility that the switch may transfer attack traffic to expose the switch or the IP equipment connected to the switch to the attack.

When the automatic setting of the IP address in the DHCP is used or a VLAN automatic setting system in the VTP is used, the switch newly introduced to the network can start transferring an IP packet or a tagged frame without a setting operation. The introduction of the switch by using the automatic setting technique as described above improves the convenience for introduction.

However, when the switch, for which the filter setting for ensuring security is not performed, operates automatically in the network, the security of the network is degraded. Moreover, when the switch, for which the log setting for monitoring the operating status is not performed, operates, the administrator cannot correctly grasp the network operating status to prevent an efficient operation of the network.

It is therefore an object of this invention to solve the problems in setting of a configuration of networking equipment by an existing management server and IP address or VLAN setting in a DHCP or a VTP to reduce a setting operation of operation policy to a large number of pieces of networking equipment while preventing security from being lowered.

According to an aspect of this invention, there is provided a packet transmitting apparatus included in a network, for transferring a frame in the network, including: a storage unit for storing a configuration of this apparatus; a memory for storing a control program; a processor for executing the control program stored in the memory; a line interface including a plurality of ports; and a switch connected to the interface. The packet transmitting apparatus a configuration managing module for setting a frame transfer function and a filter function based on the configuration; a configuration setting module for providing an interface that accepts an instruction regarding the configuration for an administrator; and a configuration transmitting/receiving module for transmitting and receiving the configuration to/from another packet transmitting apparatus; the configuration managing module, the configuration setting module, and the configuration transmitting/receiving module being implemented by the control program executed by the processor. The switch filters a frame to be transferred based on a set filtering condition. The configuration transmitting/receiving module makes a request for a configuration to the another packet transmitting apparatus included in the network, receives the configuration from the another packet transmitting apparatus, updates the configuration of this apparatus based on the received configuration, and notifies the configuration managing module of the update of the configuration. The configuration managing module obtains, upon reception of the notification of the update of the configuration from the configuration transmitting/receiving module, the updated configuration from the storage unit, and sets the filtering condition based on the obtained configuration.

According to this invention, for addition of a switch, the setting to the switch for reflecting the operation policy of the existing network can be simplified. As a result, an amount of work of a network administrator can be reduced.

### BRIEF DESCRIPTION OF THE DRAWINGS

The present invention can be appreciated by the description which follows in conjunction with the following figures, wherein:

FIG. 1 is a configuration diagram of a network including switches according to a first embodiment;

FIG. 2 is another configuration diagram of the network including the switches according to the first embodiment;

FIG. 3 is a sequence diagram of a configuration synchronization processing according to the first embodiment;

FIG. 4 is an explanatory view of a format of a configuration request message according to the first embodiment;

FIG. 5 is an explanatory view of a format of a configuration notification message according to the first embodiment;

FIG. 6 is an explanatory view of a configuration field in the configuration notification message according to the first embodiment;

FIG. 7 is an explanatory view of a configuration field in another structure of the configuration notification message according to the first embodiment;

FIG. 8 is a functional block diagram of the switch according to the first embodiment;

FIG. 9 is a block diagram of the switch according to the first embodiment;

FIG. 10 is an explanatory view of an example of description in a configuration of a new switch according to the first embodiment;

FIG. 11 is an explanatory view of another example of description in the configuration of the new switch according to the first embodiment;

FIG. 12 is an explanatory view of a configuration synchronization instruction screen according to the first embodiment;

FIG. 13 is an explanatory view of a configuration synchronization processing according to the first embodiment;

FIG. 14 is a flowchart of a processing when an administrator executes a configuration request operation according to the first embodiment;

FIG. 15 is a flowchart of the configuration synchronization processing via a designated port according to the first embodiment;

FIG. 16 is a flowchart of the configuration synchronization processing via an active port according to the first embodiment;

FIG. 17 is a flowchart of a configuration update processing according to the first embodiment;

FIG. 18 is a configuration diagram of a filter rule table according to the first embodiment;

FIG. 19 is a flowchart of a configuration transmission processing according to the first embodiment;

FIG. 20 is a sequence diagram of a configuration synchronization processing according to a second embodiment;

FIG. 21 is an explanatory view of the configuration synchronization processing according to the second embodiment;

FIG. 22 is a flowchart of a processing when an administrator executes a configuration request operation according to the second embodiment;

FIG. 23 is another sequence diagram of the configuration synchronization processing according to the second embodiment;

FIG. 24 is a sequence diagram of a configuration synchronization processing according to a third embodiment;

FIG. 25 is an explanatory view of a configuration synchronization instruction screen according to the third embodiment;

FIG. 26 is an explanatory view of the configuration synchronization processing according to the third embodiment;

FIG. 27 is a flowchart of a configuration transmission processing according to the third embodiment;

FIG. 28 is a flowchart of the configuration synchronization processing according to the third embodiment;

FIG. 29 is a sequence diagram of a configuration synchronization processing according to a fourth embodiment;

FIG. 30 is an explanatory view of a format of a status notification message according to the fourth embodiment;

FIG. 31 is an explanatory view of the configuration synchronization processing according to the fourth embodiment;

FIG. 32 is an explanatory view of a synchronization status management table according to the fourth embodiment;

FIG. 33 is an explanatory view of a transition of a synchronization status according to the fourth embodiment;

FIG. 34 is a status transition diagram of a setting status according to the fourth embodiment;

FIG. 35 is a flowchart of a status notification transmission processing according to the fourth embodiment;

FIG. 36 is a flowchart of a status notification reception processing according to the fourth embodiment;

FIG. 37 is a flowchart of a configuration request processing according to the fourth embodiment;

FIG. 38 is a sequence diagram of a configuration synchronization processing according to a fifth embodiment;

FIG. 39 is an explanatory view of a configuration field in a configuration notification message according to the fifth embodiment;

FIG. 40 is an explanatory view of the configuration synchronization processing according to the fifth embodiment;

FIG. 41 is a block diagram of a switch according to the fifth embodiment;

FIG. 42 is a configuration diagram of a filter rule table according to the fifth embodiment;

FIG. 43 is a configuration diagram of a configuration notification management table according to the fifth embodiment;

FIG. 44 is a flowchart of a configuration transmission processing according to the fifth embodiment;

FIG. 45 is a flowchart of the configuration transmission processing according to the fifth embodiment;

FIG. 46 is a flowchart of a port lookup processing according to the fifth embodiment;

FIG. 47 is an explanatory view of a configuration field in the configuration notification message according to a sixth embodiment;

FIG. 48 is a sequence diagram of a configuration synchronization processing according to the sixth embodiment;

FIG. 49 is an explanatory view of the configuration synchronization processing according to the sixth embodiment;

FIG. 50 is an explanatory view of the configuration synchronization processing according to the sixth embodiment;

FIG. 51 is a flowchart of a configuration confirmation processing according to the sixth embodiment;

FIG. 52 is a flowchart of the configuration confirmation processing according to the sixth embodiment;

FIG. 53 is a configuration diagram of a network including switches according to a seventh embodiment;

FIG. 54 is a configuration diagram of the network including the switches according to the seventh embodiment;

FIG. 55 is a block diagram of the switch according to the seventh embodiment; and

FIG. 56 is a configuration diagram of a network including switches according to an eighth embodiment.

### DETAILED DESCRIPTION OF THE PREFERRED EMBODIMENTS

First, the general outline of embodiments of this invention will be described.

In order to solve the above-described problems, a switch (or a router) according to the embodiments of this invention includes a configuration transmitting/receiving module which transmits/receives the content of a configuration to/from another switch. The configuration transmitting/receiving module transmits/receives the content of the configuration to/from the neighboring switch in cooperation with a configuration managing module and a configuration setting module provided in the switch.

Upon connection of the newly installed switch (hereinafter, referred to simply as the “new switch”), the configuration transmitting/receiving module of the already installed switch (hereinafter, referred to simply as the “existing switch”) notifies the new switch of the configuration in response to a request from the new switch. The configuration contains security setting and management setting.

The existing switch notifies the configuration in response to an instruction from a setting interface or automatically after having recognized a transition of a connected port to an active status.

Upon activation, the configuration transmitting/receiving module of the new switch looks up a port in an active status to request the existing switch to transfer the configuration. The new switch also requests the transfer of the configuration in response to an instruction from the setting interface or according to the content described in the configuration.

Then, upon reception of the configuration containing the security setting and the management setting from the existing switch, the configuration transmitting/receiving module of the new switch updates the configuration of the self apparatus to notify its configuration managing module of the update of the configuration. Upon reception of the update notification of the configuration, the configuration managing module reads out the updated configuration to set a security setting item and an operation management setting item of the switch.

The switch according to the embodiments of this invention includes a connected equipment management table containing a synchronization status of the configuration with a neighboring switch connected to a port of the line interface, and a connected equipment management functional module which creates and updates an entry on the connected equipment management table.

The switch according to the embodiments of this invention also includes an authentication status, management table containing an authentication status of the neighboring switch connected to the port of the line interface. An entry in the authentication status management table is referred to by the configuration transmitting/receiving module.

Upon connection of the newly introduced switch to the switch being operated in the network, before notifying the new switch of the configuration, the existing switch authenticates the new switch to judge whether or not to notify of the configuration. Then, the existing switch records the result of judgment in the authentication status management table.

For notifying the new switch of the configuration upon reception of the request message or in response to the instruction from the setting interface, the existing switch refers to the above-described authentication status management table. Only when the notification of the configuration is authorized, the existing switch notifies of the configuration.

As described above, according to the embodiments of this invention, when a new switch is introduced to expand the network according to an increase in number of host computers, the quantity of work required for the administrator to set the filter rule can be reduced. Moreover, uniform security policy can be reflected on the switches provided in the network.

The reduced quantity of work for a person in charge for network construction/operation allows the information system division of a company to construct a large-scale network without any outsourcing of the network construction work.

Hereinafter, the embodiments of this invention will be described with reference to the accompanying drawings.

### First Embodiment

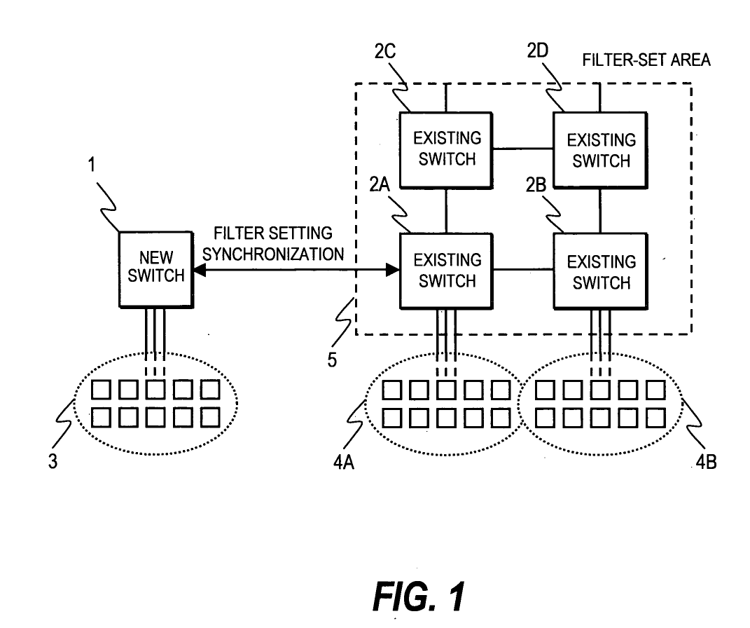

FIG. 1 is a configuration diagram of a network including a switch according to a first embodiment.

An existing network 5 includes switches 2A to 2D, each transferring a frame in the network.

A filter rule is set for the switches 2A to 2D. Frame and packet are selected based on the set filter rule to discard unnecessary frames and packets. As a result, policy that ensures the network security is operated.

In the first embodiment, a case where a switch 1 serving to connect an added computer to the Intranet is newly installed when the number of computers increases for the establishment of a new division, the increase of personnel, or the like will be considered. The new switch 1 is connected to the existing switch 2A. In this case, a filter setting is required to be synchronized between the switch 1 and the existing switch 2A to set the same filter rule for the new switch 1 as that set for the existing switches 2A to 2D.

Existing terminal groups 4A and 4B are connected to the switches 2A to 2D. A terminal group 3, which is newly installed, is connected to the switch 1.

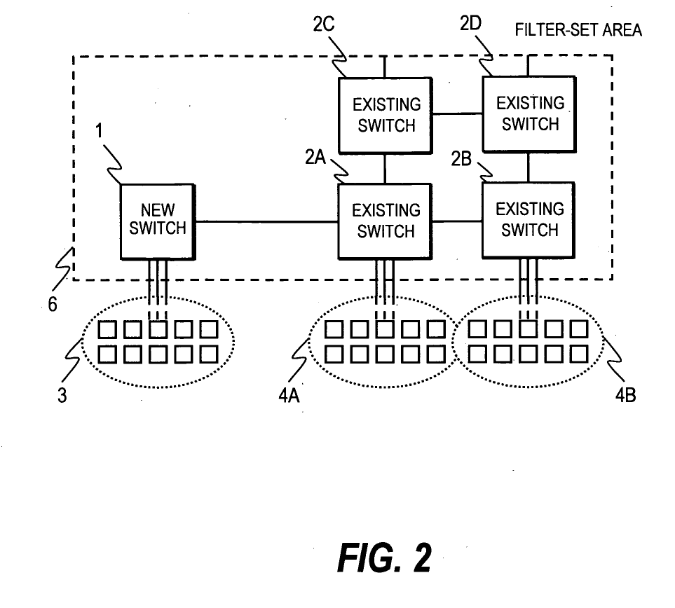

FIG. 2 is a configuration diagram of the network including the switches according to the first embodiment, which illustrates a state where the setting of the filter rule for the switch 1 is completed.

Upon completion of the setting of the same filter rule in the switch 1 as that in the existing switches 2A to 2D, the area of the network, to which the filter rule is applied, is expanded to include the switches 1 and 2A to 2D. To be specific, all the traffic transmitted to/received from the newly installed terminal group 3 and the existing terminal groups 4A and 4B is to be filtered.

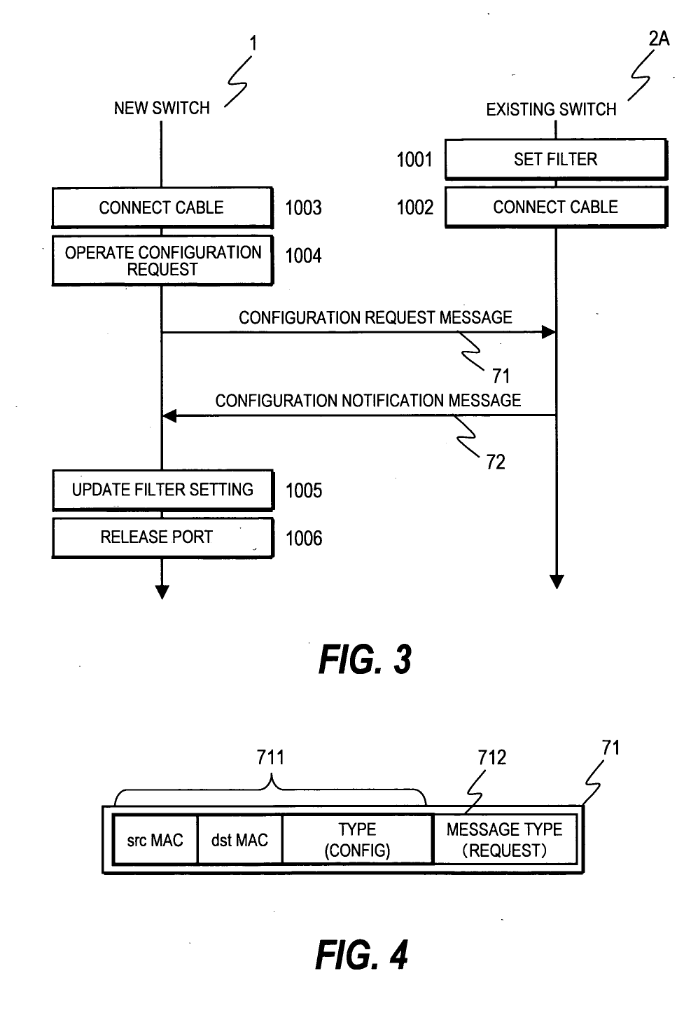

FIG. 3 is a sequence diagram of a configuration synchronization processing between the new switch and the existing switch 2A according to the first embodiment.

The filter rule is set for the existing switch 2A (1001), and the existing switch 2A is operating in the network 5.

After that, for the expansion of the network, an administrator connects the existing switch 2A and the new switch 1 to each other through a cable (1002 and 1003).

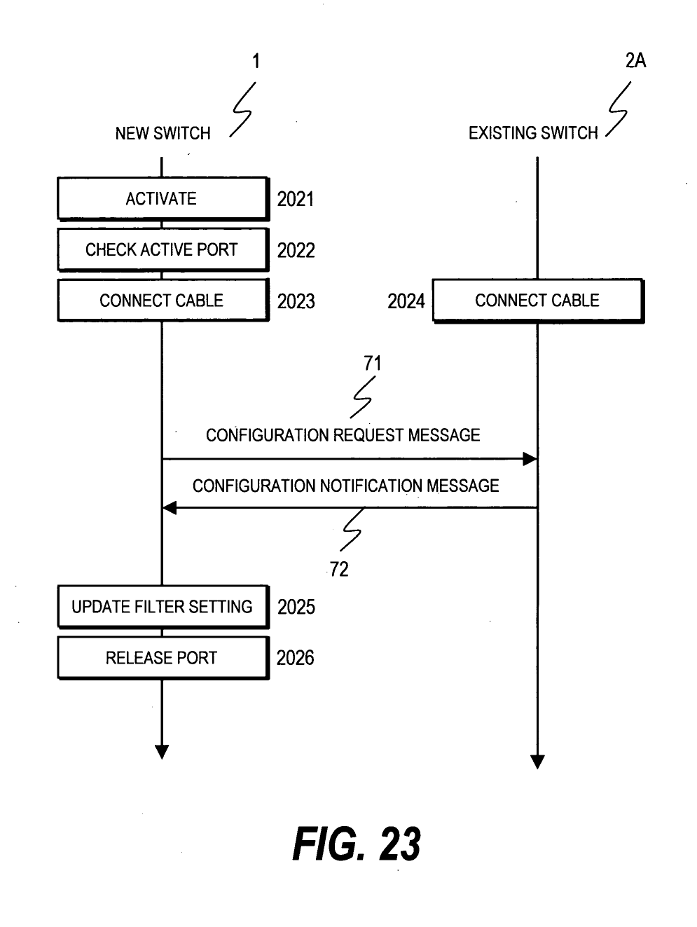

The new switch 1 monitors a voltage applied to a port to confirm the connection of the cable to the port (1003). After that, when the administrator uses an input/output device 104 to instruct a configuration request (1004), a configuration request message 71 is transmitted to the existing switch 2A. As described in a second embodiment shown in FIG. 23, the configuration request message 71 may be transmitted upon linkup of a line interface as a result of the connection to the existing switch 2A.

Upon reception of the configuration request message 71 from the new switch 1, the existing switch 2A reads out a configuration 24 to create a configuration notification message 72 that includes the readout configuration. Then, the existing switch 2A returns the created configuration notification message 72 to the new switch 1 as a response to the configuration request message 71.

The new switch 1 receives the configuration notification message 72 to obtain the configuration set in the existing switch 2A. The new switch 1 updates the configuration of the self apparatus with the obtained configuration. In addition, the new switch 1 extracts the filter setting from the configuration notification message 72 to update the filter setting (1005).

Upon termination of the filter setting, the new switch 1 releases the port to which the terminal group 3 is connected to start frame transfer (1006).

As described above, by obtaining the filter setting on the switch 2A on the existing network, the quantity of work for the initial setting, which has conventionally been performed by the administrator, can be reduced. In addition, by replicating the content of setting, with which the operation has already been confirmed, an unintended operation of the equipment, which is caused by human error in initial setting, can be prevented to enable the stable operation of the network even for the network expansion.

By using the switch to which this invention is applied, when a new switch is introduced into the network, the same security policy such as a filter rule can be uniformly applied. As a result, the security can be prevented from being lowered due to inconsistent security policy.

FIG. 4 is an explanatory view of a format of the configuration request message 71 according to the first embodiment.

The configuration request message 71 contains a header 711 and a message type field 712. The header 711 contains a destination field, a source field, and a Type field.

The destination field of the header 711 includes a MAC address of the existing switch 2A. The source field of the header 711 includes a MAC address of the new switch 1. The Type field of the header 711 includes an identifier indicating that the message is used for a configuration synchronization processing of the first embodiment.

The message type field 712 includes an identifier indicating that the message is a request of the configuration.

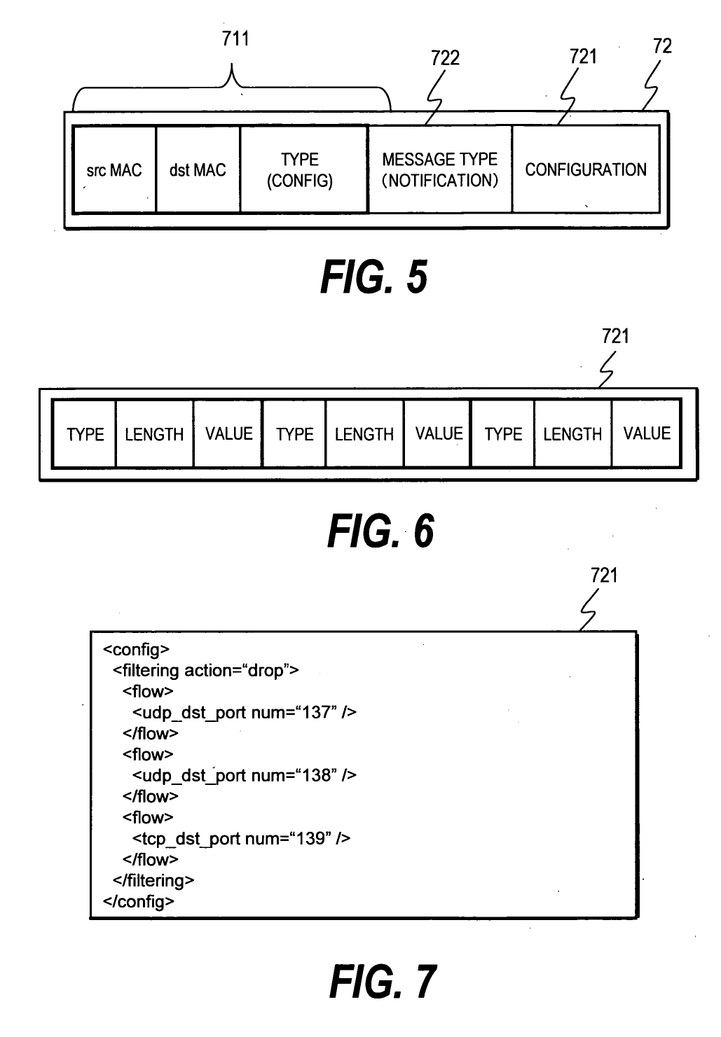

FIG. 5 is an explanatory view of a format of the configuration notification message 72 according to the first embodiment.

The configuration notification message 72 contains the header 711, a message type field 722, and a configuration field 721. As in the case of the configuration request message, the header 711 contains a destination field, a source field, and a Type field.

The destination field of the header 711 includes a MAC address of the existing switch 2A. The source field of the header 711 includes a MAC address of the new switch 1. The Type field of the header 711 includes an identifier indicating that the message is used for a configuration synchronization processing of the first embodiment.

The message type field 722 includes an identifier indicating that the message is a notification of the configuration. The configuration field 721 includes the content of the configuration to be notified to the request source switch.

FIG. 6 is an explanatory view of the configuration field 721 in the configuration notification message 72 according to the first embodiment.

The configuration field 721 is configured in a TLV format containing a type at a fixed length, a data length at a fixed length, and data at a variable length to store the content of the configuration.

FIG. 7 is an explanatory view of another configuration field 721 in the configuration notification message 72 according to the first embodiment.

In the configuration field 721 shown in FIG. 7, filter rule setting is described in an Extensible Markup Language (XML).

In the configuration field 721, the setting for discarding a UDP packet with a destination port number 137 or 138 and a TCP packet with a destination port number 139 through filtering is described.

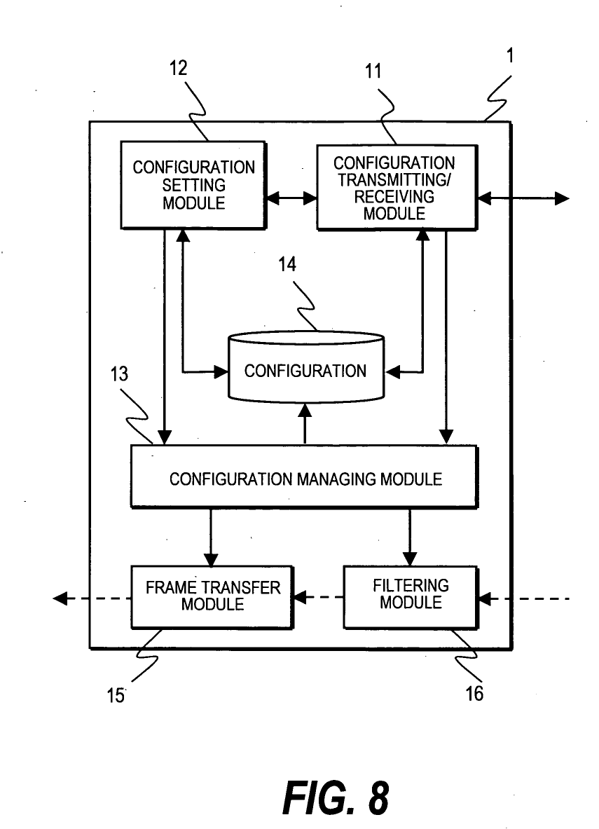

FIG. 8 is a functional block diagram of the switch 1 according to the first embodiment.

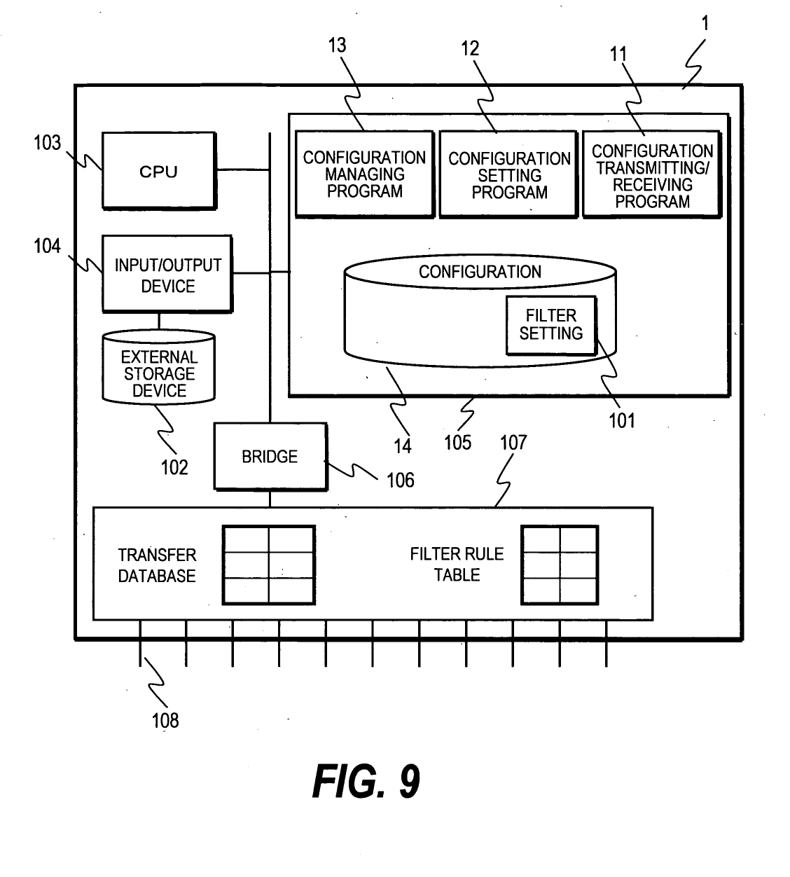

The switch 1 includes a configuration transmitting/receiving module 11, a configuration setting module 12, a configuration managing module 13, configuration data 14, a frame transfer module 15, and a filtering module 16. Although only the switch 1 will be described with reference to FIGS. 8 and 9, the other switches 2A to 2D have the same configuration.

The frame transfer module 15 transfers an input frame to a predetermined destination. The filtering module 16 discards a frame meeting a preset condition (or transfers only a frame meeting a preset condition). Therefore, only a frame predetermined by the frame transfer module 15 and the filtering module 16 is transferred.

The configuration managing module 13 manages the configuration data 14 which controls an operation of the switch. The configuration setting module 12 creates and updates the configuration data 14 managed by the configuration managing module 13 via a dedicated interface or a line interface. The configuration transmitting/receiving module 11 transmits/receives a configuration to/from a connected switch.

FIG. 9 is a block diagram of the switch 1 according to the first embodiment.

The switch 1 includes a CPU (processor) 103, the input/output device 104, a memory 105, an external storage device 102, a bridge 106, and a switching module 107. The CPU 103, the input/output device 104, and the memory 105 are connected to one another through an internal bus.

The CPU 103 executes various programs stored in the memory 105.

The input/output device 104 is an interface that inputs/outputs setting data to/from the switch 1. For example, a serial interface such as RS-232C is used for input/output data. The input/output device 104 may include an input unit and a display unit to allow the administrator to directly input data to the switch 1.

The memory 105 stores various programs executed by the CPU 103 and data. To be specific, the memory 105 stores a configuration transmitting/receiving program 11, a configuration setting program 12, a configuration managing program 13, and configuration data 14. The configuration data 14 contains a filter setting 101.

The external storage device 102 consists of a flash memory, a hard disk drive, or the like to store the programs and the data stored in the memory 105. Then, upon activation of the switch, the programs and data are read from the external storage device 102 to be expanded in the memory 105.

The bridge 106 serves to connect the internal bus of the switch 1 and the switching module 107 to each other to bridge the data therebetween.

The switching module 107 includes a plurality of ports 108, a switch which connects the ports 108, a transfer database, and a filter rule table. The filter rule table is created based on the filter setting 101 in the configuration 14.

The switching module 107 switches the connection of the ports 108 to switch an input frame. To be specific, the switching module 107 refers to the transfer database to determine a destination of transfer of the frame input to the port 108 and to output the frame to the determined destination port.

The switching module 107 also filters input frames. To be specific, the switching module 107 analyzes a header of the input frame to compare the result of analysis with the filter rule table. Then, the switching module 107 judges whether or not to transfer the input frame, and outputs the frame allowed to be transferred to the determined destination port. On the other hand, the switching module 107 discards the frame not to be transferred.

In addition, a memory that temporarily accumulates input frames may be connected to the switching module 107.

Although only one switching module 107 is illustrated, the switch may include a plurality of switching modules. Alternatively, the plurality of switching modules 107 may be unified as a single transfer module to include a frame storage memory.

Alternatively, the CPU 103, the input/output device 104, and the memory 105 may be unified as a single control module. In this manner, the switch can have a distributed configuration in which one or a plurality of transfer modules are connected to one or a plurality of control modules (for example, connected through a crossbar switch).

The switch according to this embodiment may omit the switching module 107 so that a plurality of line interfaces are connected to the CPU through the internal bus. In this manner, the switch can have a centralized processing configuration in which frame switching is realized by software executed in the CPU 103.

Next, an operation of each of the modules in the switch when the content of the configuration that describes the filter rule is reflected from the existing switch 2A to the new switch 1 will be described.

First, an example of explicit description in the configuration of the new switch will be described.

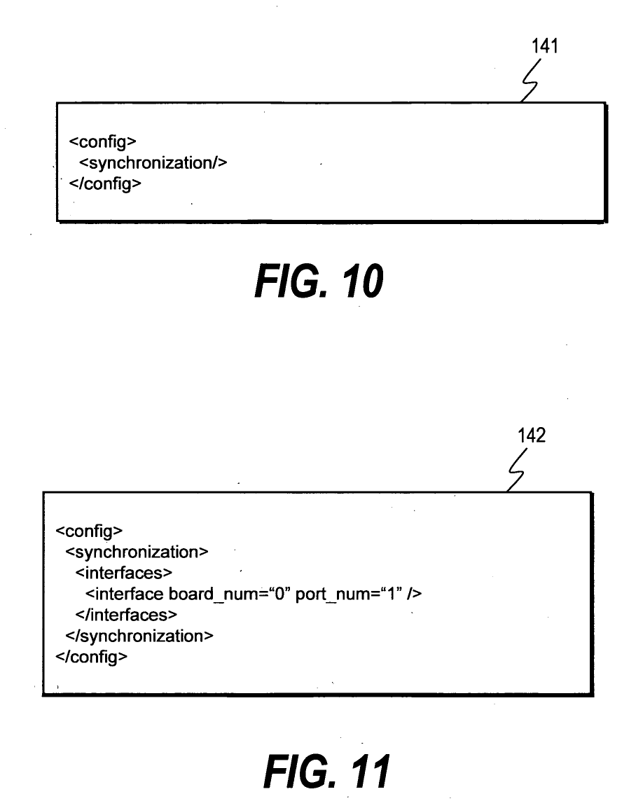

FIG. 10 is an explanatory view of an example of description of the configuration of the new switch according to the first embodiment.

The configuration shown in FIG. 10 is input by the administrator through the input/output device 104.

A <synchronization/> element in a configuration 141 instructs the switch to synchronize the configuration with that of an external switch.

FIG. 11 is an explanatory view of another example of description of the configuration of the new switch according to the first embodiment.

An <interface> element is described in a <synchronization> element in a configuration 142 to designate a port of a line interface used for configuration synchronization. In this case, a port 1 of a board 0 is designated. In this case, a message is exchanged between the existing switch 2A and the new switch 1 via the port designated by the <interface> element in the configuration of the new switch 1.

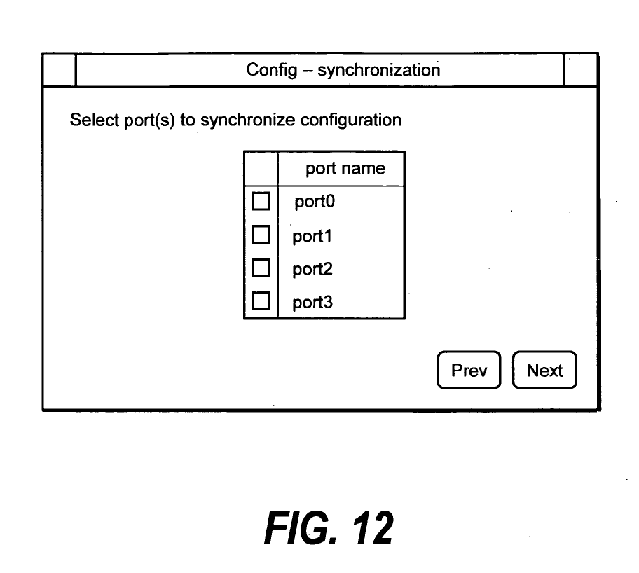

FIG. 12 is an explanatory view of a screen that instructs the new switch to synchronize the configuration according to the first embodiment.

The administrator operates the input/output device 104 of the new switch 1 to designate a port used for configuration synchronization. On the setting screen, a plurality of ports are displayed. The administrator designates the port of the new switch, which is to be used for the configuration synchronization, among the plurality of displayed ports.

The input/output device 104 displays the result of checking the appropriateness of the port number (validity/invalidity and active status/inactive status of the port). When the port is valid and active, the success or failure of the configuration synchronization via the corresponding port is displayed on the input/output device 104.

The input/output device 104 can be configured to allow the administrator to designate the port used for configuration synchronization through a command line interface. In this case, the administrator inputs command strings indicating the configuration synchronization and a used port number.

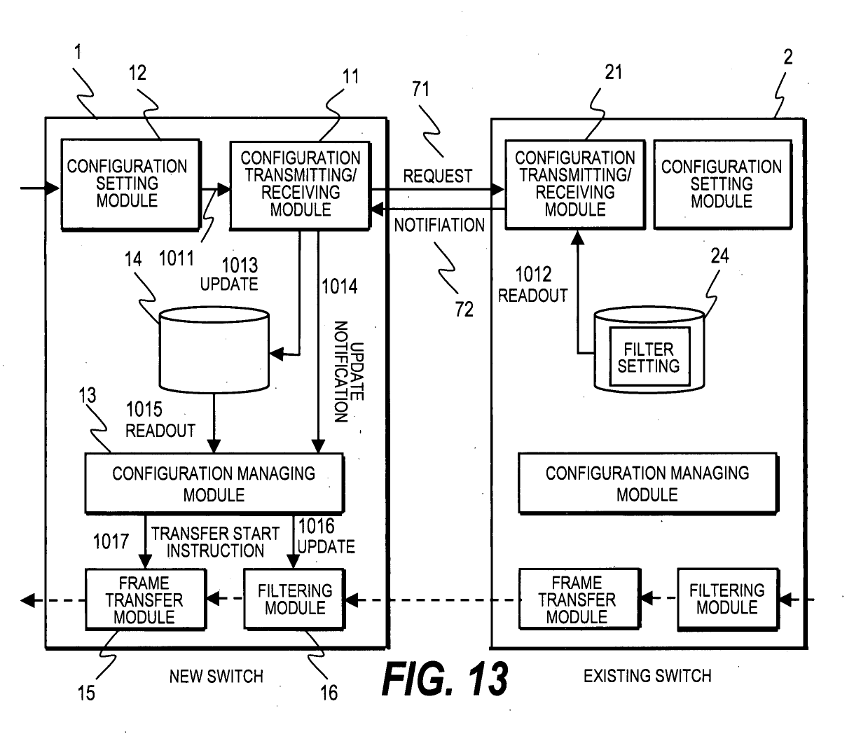

FIG. 13 is an explanatory view of a synchronization processing of the configuration according to the first embodiment, illustrating the communication of a message in the switch and between the switches when a synchronization instruction of the configuration with the existing switch 2A is described in the configuration 14 of the new switch 1.

First, upon activation of the new switch 1, the configuration setting module 12 notifies the configuration transmitting/receiving module 11 of a configuration synchronization instruction which is input by the administrator to the input/output device 104 (1011).

Upon reception of the configuration synchronization instruction input by the administrator, the configuration transmitting/receiving module 11 analyzes a used port number contained in the received synchronization instruction. Then, the configuration transmitting/receiving module 11 checks the validity of the port of the analyzed number and the active status of the port. When the port is available (valid and active), the configuration request message 71 is transmitted to the configuration transmitting/receiving module 21 of the existing switch 2.

Upon reception of the configuration request message 71 from the new switch 1, the configuration transmitting/receiving module 21 of the existing switch 2 reads out the content of the configuration 24 (1012) to create the configuration notification message 72 that includes the content of the configuration 24. Then, the configuration transmitting/receiving module 21 returns the created configuration notification message 72 to the new switch 1.

Upon reception of the configuration notification message 72 from the existing switch 2, the configuration transmitting/receiving module 11 of the new switch 1 extracts the configuration from the received message to update the configuration 14 of the self apparatus with the content of the extracted configuration (1013). After that, the configuration transmitting/receiving module 11 notifies the configuration managing module 13 of the update of the configuration (1014).

Upon reception of the update notification of the configuration from the configuration transmitting/receiving module 11, the configuration managing module 13 reads out the configuration 14 in the self apparatus (1015) to apply the updated filter rule to the filtering module 16 (1016). After that, the configuration managing module 13 instructs the frame transfer module 15 to start the frame transfer (1017).

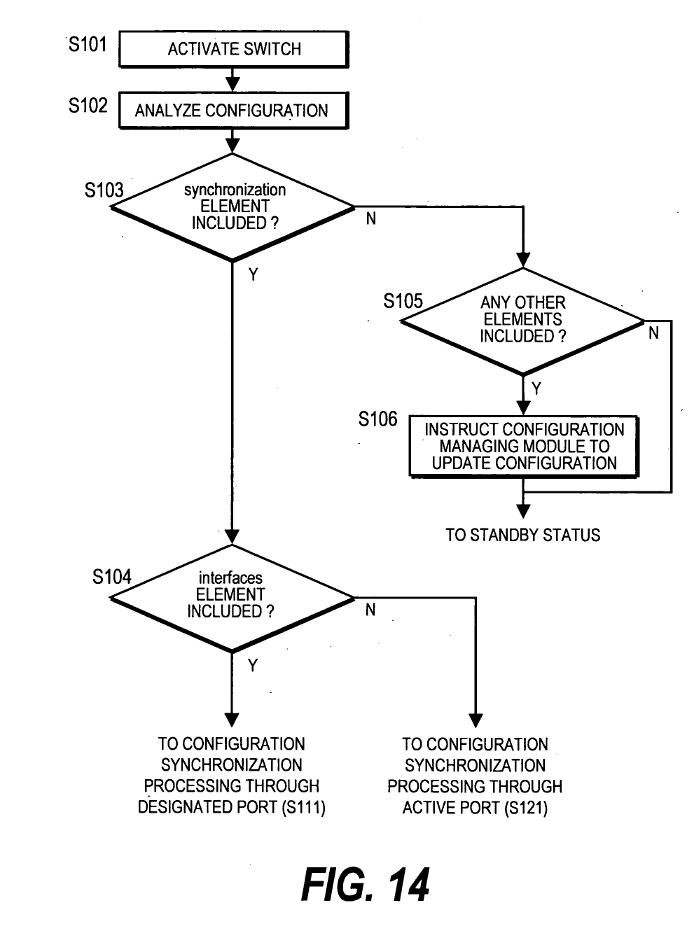

FIG. 14 is a flowchart of a processing when the administrator executes a configuration request operation according to the first embodiment, the processing being executed in the configuration transmitting/receiving module 11.

Upon activation of the switch 1 (S101), the configuration setting module 12 transmits a configuration input by the administrator to the configuration transmitting/receiving module 11.

Upon reception of the configuration input by the administrator, the configuration transmitting/receiving module 11 analyzes the content of the configuration (S102) to check whether or not the configuration contains a <synchronization> element which instructs the synchronization with the existing switch (S103).

As a result, when the configuration does not contain the <synchronization> element, it is judged that the synchronization with the existing switch 2A is not required. Then, it is further checked whether or not the configuration contains any elements other than the <synchronization> element (S105). As a result, when any other elements do not exist, the configuration transmitting/receiving module 11 returns to a standby status. On the other hand, when any other elements exist, the configuration transmitting/receiving module 11 instructs the configuration managing module 13 to update the configuration with the content input by the administrator (S106). After that, the configuration transmitting/receiving module 11 returns to a standby status.

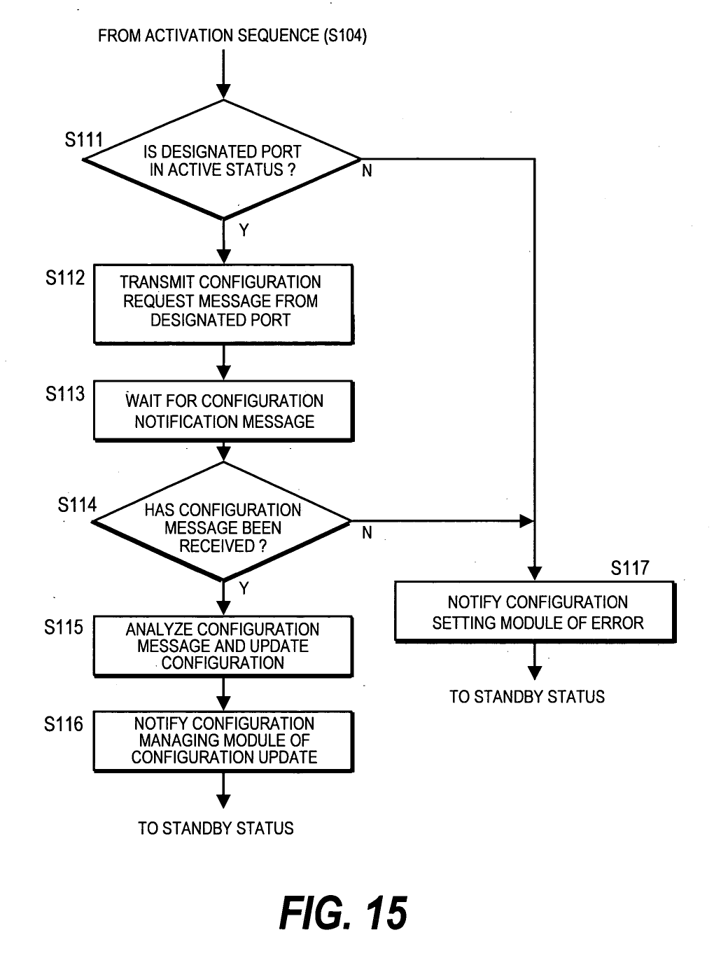

On the other hand, when the <synchronization> element exists, it is judged that the synchronization with the existing switch 2A is required. Then, it is further checked whether or not an <interface> element is contained in the <synchronization> element (S104). When the <interface> element is contained in the <synchronization> element, the configuration request message 71 and the configuration notification message 72 are transmitted to/received from the existing switch 2A through a port designated by the <interface> element, as shown in FIG. 15.

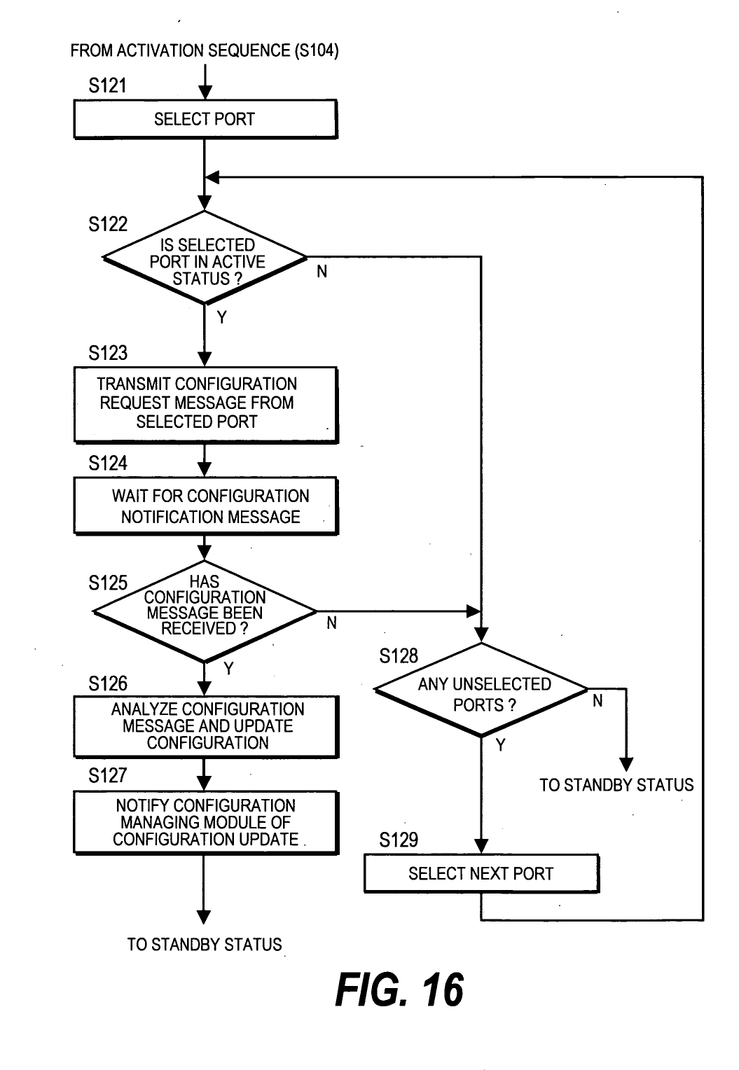

On the other hand, when the <interface> element does not exist, the configuration request message 71 and the configuration notification message 72 are transmitted to/received from the existing switch 2A through an active port, as shown in FIG. 16.

FIG. 15 is a flowchart of a processing which synchronizes the configuration through a designated port according to the first embodiment.

The configuration synchronization processing shown in FIG. 15 is executed in the configuration transmitting/receiving module 11 when a port used for synchronization is designated in the configuration input by the administrator.

First, the configuration transmitting/receiving module 11 analyzes a board attribute and a port attribute in the <interface> element in the configuration to obtain a port used for synchronization. Then, the configuration transmitting/receiving module 11 checks the validity and the active status of the corresponding port (S111).

As a result, when the port used for synchronization is invalid or not in an active status, the configuration transmitting/receiving module 11 notifies the configuration setting module 12 of an error. At this time, it is recommended that the content of the error also be notified (S117). After that, the configuration transmitting/receiving module 11 returns to a standby status without obtaining the configuration from the existing switch 2A.

On the other hand, when the port used for synchronization is valid and in an active status, the configuration is obtained through the corresponding port. To be specific, the configuration transmitting/receiving module 11 creates the configuration request message 71 to transmit the thus created message from the designated port (S112).

After that, the configuration transmitting/receiving module 11 waits for the configuration notification message 72 at the designated port (S113). Then, upon reception of the configuration notification message 72 (S114), the configuration transmitting/receiving module 11 analyzes the configuration field in the configuration notification message 72 to update the configuration 14 of the new switch 1 with the content of the notified configuration (S115). After that, the configuration transmitting/receiving module 11 notifies the configuration managing module 13 of the update of the configuration (S116).

When a predetermined time has elapsed without reception of the configuration notification message after the transmission of the configuration request message, the configuration transmitting/receiving module 11 notifies the configuration setting module 12 of an error. Then, the configuration transmitting/receiving module 11 terminates the synchronization processing of the configuration to return to the standby status.

FIG. 16 is a flowchart of a processing which synchronizes the configuration through an active port according to the first embodiment. The configuration synchronization processing shown in FIG. 16 is executed in the configuration transmitting/receiving module 11 when a port used for synchronization is designated in the configuration input by the administrator.

The new switch 1 looks up a port in an active status to obtain the configuration from the existing switch 2A via the port in the active status.

First, the configuration transmitting/receiving module 11 selects one from the ports provided for the new switch 1 (S121) to check whether or not the selected port is in the active status (S122).

As a result, when the selected port is not in the active status, it is then checked whether or not the switch 1 has any unselected ports (S128). As a result, when the unselected port is found, a next port is selected and the configuration transmitting/receiving module 11 returns to Step S122. On the other hand, when no unselected port is found, the configuration transmitting/receiving module 11 returns to the standby status because all the ports have been checked.

On the other hand, when the selected port is in the active status, the configuration transmitting/receiving module 11 creates the configuration request message 71 to transmit the created message from the designated port (S123).

After that, the configuration transmitting/receiving module 11 waits for the configuration notification message 72 at the designated port (S124). Then, upon reception of the configuration notification message 72 (S125), the configuration transmitting/receiving module 11 analyzes the configuration field in the configuration notification message 72 to update the configuration 14 of the new switch 1 with the content of the notified configuration (S126). After that, the configuration transmitting/receiving module 11 notifies the configuration managing module 13 of the update of the configuration (S127).

After a predetermined time has elapsed without reception of the configuration notification message since the transmission of the configuration request message, the configuration transmitting/receiving module 11 checks whether or not the switch 1 has any unselected ports (S128). As a result, when any unselected port is found, the configuration transmitting/receiving module 11 selects a next port and returns to Step S122. On the other hand, when no unselected port is found, the configuration transmitting/receiving module 11 returns to the standby status because all the ports have been checked.

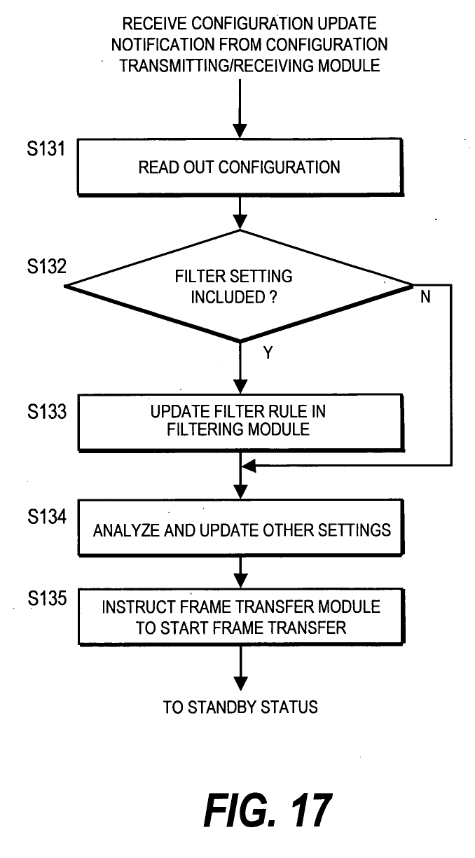

FIG. 17 is a flowchart of a configuration update processing according to the first embodiment, the processing being executed in the configuration managing module 13.

Upon reception of the update notification from the configuration transmitting/receiving module 11, the configuration managing module 13 of the new switch 1 reads out the configuration 14 (S131) to set the frame transfer module 15 and the filtering module 16 according to the content of description of the configuration.

To be specific, the configuration managing module 13 checks whether or not the readout configuration contains a filter setting (S132). As a result, when the readout configuration contains the filter setting, the configuration managing module 13 updates the filter rule stored in the filtering module 16 according to the content of the readout configuration (S133).

Furthermore, if any other setting is needed, the configuration managing module 13 analyzes the readout configuration to update the configuration (S134).

After that, the configuration managing module 13 releases a port from which a frame is to be transferred to instruct the frame transfer module 15 to start the frame transfer (S135).

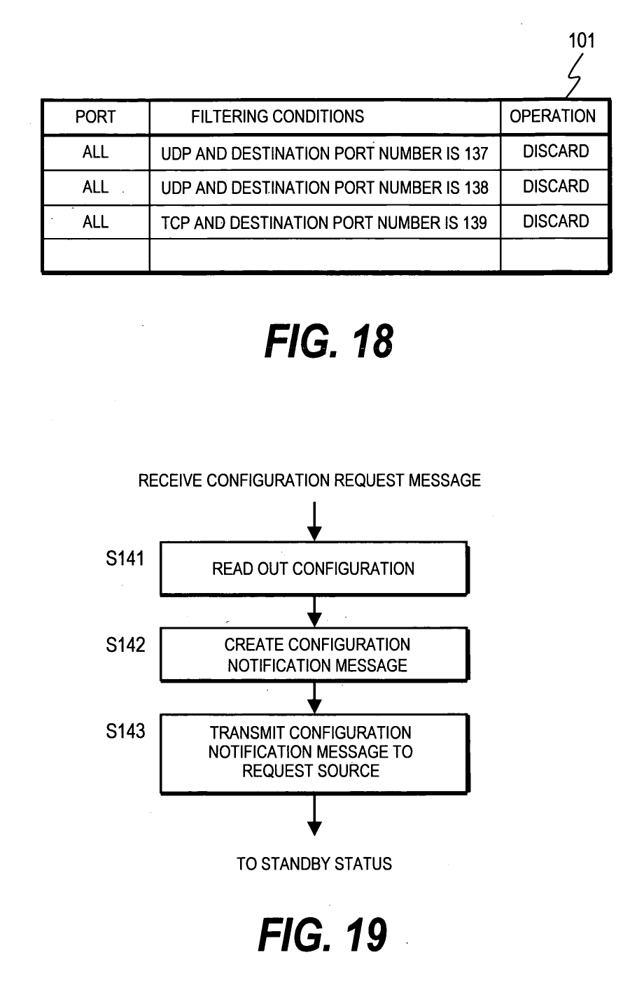

FIG. 18 is a configuration diagram of a filter rule table 101 according to the first embodiment.

The filter rule table 101 is created by the configuration managing module 13 according to the read configuration 142.

The filter rule table 101 contains data of ports, filtering conditions, and operation.

The filtering module 16 performs a processing defined in the operation on a frame meeting the filtering conditions according to the filter rule table 101.

To be specific, when the configuration transmitting/receiving module 11 receives the configuration shown in FIG. 7 to notify the configuration managing module 13 of the update of the configuration, the configuration managing module 13 sets the filtering module 16 to discard a UDP packet with a destination port number 137, a UDP packet with a destination port number 138, and a TCP packet with a destination port number 139.

FIG. 19 is a flowchart of a configuration transmission processing according to the first embodiment, the processing being executed in the configuration transmitting/receiving module 21.

Upon reception of the configuration request message 71 from the configuration transmitting/receiving module 11 of the new switch 1, the configuration transmitting/receiving module 21 of the existing switch 2A reads out the configuration 24 of the existing switch 2A (S141). Then, the configuration transmitting/receiving module 21 creates the configuration notification message 72 containing the configuration field that stores the readout content (S142). Then, the configuration transmitting/receiving module 21 returns the created configuration notification message 72 from the port that has received the configuration request message 71 (S143) to return to the standby status.

As described above, upon connection to the network in operation, the switch 1 according to the first embodiment receives the configuration containing the filter setting from the existing switch 2A to reflect the received configuration on the setting of the self apparatus. As a result, it is no longer necessary to describe a filter rule for reflecting the security polity of the network in operation. Since the administrator is not required to perform an operation for describing the filter rule with the introduction of the new switch, operation cost with the expansion of the network can be reduced.

Moreover, by using the switch according to the first embodiment, an error of the administrator in operation for switch installation can be prevented. Since an error in the content of setting in the security setting containing the filter rule setting in the configuration of the switch lowers the network security, a designated protocol or port number is required to be described in the configuration without any error.

For the switch according to this invention, the setting of the security in operation and the setting of operation management of the network can be applied to the new switch 1 without the operation of the administrator. As a result, the security can be prevented from being lowered by an error in operation, while the management setting can be prevented from not being applied.

### Second Embodiment

A switch according to a second embodiment of this invention detects the connection of another switch to a port of the self apparatus upon activation to automatically obtain the configuration from the connected switch. In this case, even when the configuration read after activation does not contain the <synchronization> element, the switch automatically looks up a port in the active status to obtain the configuration from the existing switch.

In the second embodiment, since the switch configuration is the same as that of the first embodiment described above except for differences described below, the same components are denoted by the same reference numerals and the description thereof is herein omitted.

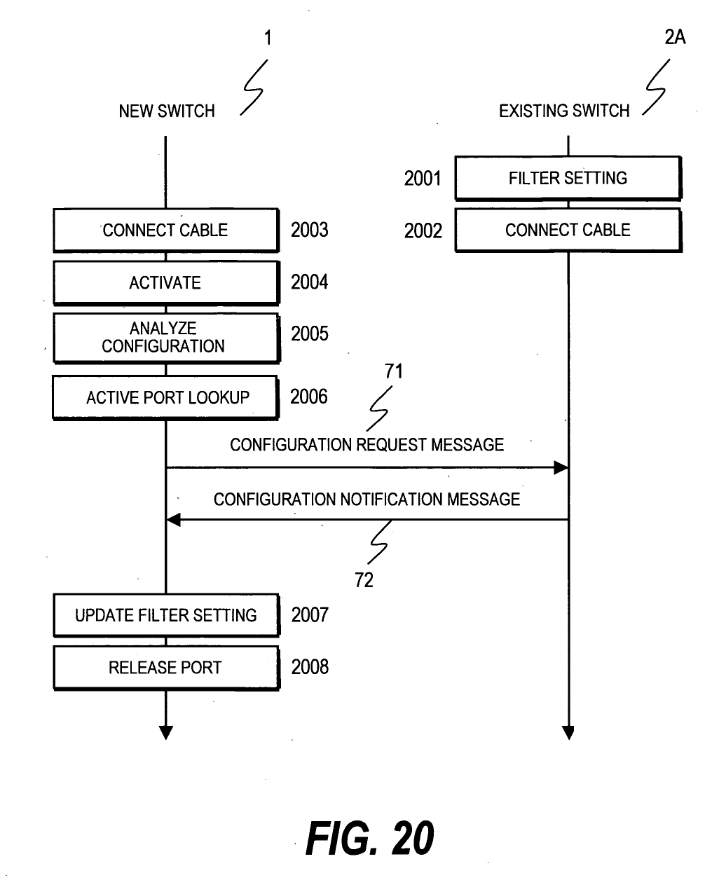

FIG. 20 is a sequence diagram of a configuration synchronization processing between the new switch 1 and the existing switch 2A according to the second embodiment.

In the second embodiment, when the configuration is not defined, an active port is automatically looked up to obtain the configuration.

The filter rule is set for the existing switch 2A (2001), and the existing switch 2A is operating in the network 5.

After that, for the expansion of the network, an administrator connects the existing switch 2A and the new switch 1 to each other through a cable (2002 and 2003).

After that, upon activation (2004), the new switch 1 reads out the configuration 14 of the self apparatus to analyze the content of the configuration 14 (2005). To be specific, when the configuration 14 does not contain the <synchronization> element, the new switch 1 looks up an active port (2006) to transmit the configuration request message 71 via the active port.

Upon reception of the configuration request message 71 from the new switch 1, the existing switch 2A reads out a configuration 24 to create a configuration notification message 72 that stores the readout configuration. Then, the existing switch 2A returns the created configuration notification message 72 to the new switch 1 as a response to the configuration request message 71.

The new switch 1 receives the configuration notification message 72 to obtain the configuration set in the existing switch 2A. The new switch 1 updates the configuration of the self apparatus with the obtained configuration. In addition, the new switch 1 extracts the filter setting from the configuration notification message 72 to update the filter setting (2007).

Upon termination of the filter setting, the new switch 1 releases the port, to which the terminal group 3 is connected, to start the transfer of the input frame (2008).

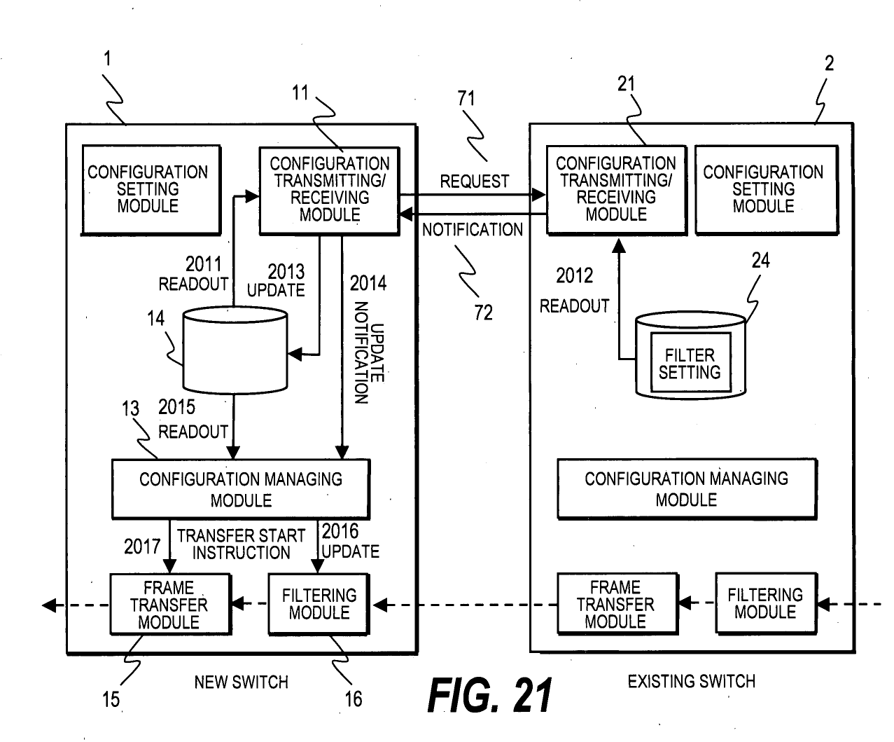

FIG. 21 is an explanatory view of a configuration synchronization processing according to the second embodiment, illustrating the communication of a message in the switch and between the switches for automatic lookup of the active port when the configuration 14 of the new switch 1 is not defined.

First, upon activation, the new switch 1 reads out the configuration 14 of the self apparatus (2011) to analyze the content of the configuration 14. After that, the new switch 1 looks up an available port. Then, via the port found by the lookup, the new switch 1 transmits the configuration request message 71 to the configuration transmitting/receiving module 21 of the existing switch 2.

Upon reception of the configuration request message 71 from the new switch 1, the configuration transmitting/receiving module 21 of the existing switch 2 reads out the content of the configuration 24 (2012) to create the configuration notification message 72 that includes the content of the configuration 24. Then, the configuration transmitting/receiving module 21 returns the created configuration notification message 72 to the new switch 1.

Upon reception of the configuration notification message 72 from the existing switch 2, the configuration transmitting/receiving module 11 of the new switch 1 extracts the configuration from the received message to update the configuration 14 of the self apparatus with the content of the extracted configuration (2013). After that, the configuration transmitting/receiving module 11 notifies the configuration managing module 13 of the update of the configuration (2014).

Upon reception of the update notification of the configuration from the configuration transmitting/receiving module 11, the configuration managing module 13 reads out the configuration 14 in the self apparatus (2015) to apply the updated filter rule to the filtering module 16 (2016). After that, the configuration managing module 13 instructs the frame transfer module 15 to start the frame transfer (2017).

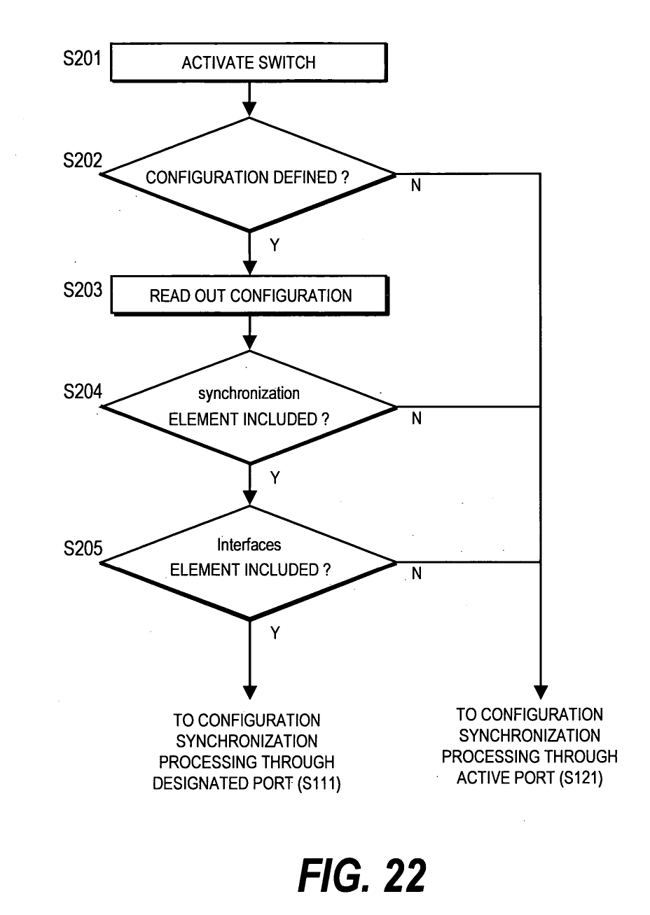

FIG. 22 is a flowchart of a processing when the administrator executes a configuration request operation according to the second embodiment, the processing being executed in the configuration transmitting/receiving module 11.

Upon activation of the switch 1 (S210), the configuration transmitting/receiving module 11 checks whether or not the configuration 14 of the self apparatus has already been defined (S202). As a result, when the configuration 14 has not been defined, the configuration transmitting/receiving module 11 transmits/receives the configuration request message 71 and the configuration notification message 72 to/from the existing switch 2A via the active port; as shown in FIG. 16.

On the other hand, when the configuration 14 has already been defined, the configuration transmitting/receiving module 11 reads out the configuration 14 to analyze the content of the readout configuration (S203). Then, the configuration transmitting/receiving module 11 checks whether or not the configuration contains the <synchronization> element that instructs the synchronization with the existing switch (S204).

As a result, when the configuration does not contain the <synchronization> element, the configuration transmitting/receiving module 11 transmits/receives the configuration request message 71 and the configuration notification message 72 to/from the existing switch 2A via the active port, as shown in FIG. 16.

On the other hand, when the <synchronization> element exists, it is judged that the synchronization with the existing switch 2A is required with a method described in the configuration. Then, it is further checked whether or not an <interface> element is contained in the <synchronization> element (S205). When the <interface> element is contained in the <synchronization> element, the configuration request message 71 and the configuration notification message 72 are transmitted to/received from the existing switch 2A through a port designated by the <interface> element, as shown in FIG. 15.

On the other hand, when the <interface> element does not exist, the configuration request message 71 and the configuration notification message 72 are transmitted to/received from the existing switch 2A through an active port, as shown in FIG. 16.

The configuration transmitting/receiving module 21 of the existing switch 2A according to the second embodiment operates in the same manner as in the case of the configuration transmission processing shown in FIG. 19 according to the first embodiment. To be specific, upon reception of the configuration request message 71, the configuration transmitting/receiving module 21 reads out the configuration 24 (S141), creates the configuration notification message containing the readout configuration (S142), and transmits the configuration notification message 72 (S143).

Moreover, the configuration managing module 13 of the new switch 1 operates in the same manner as the configuration update processing shown in FIG. 17 according to the first embodiment. To be specific, upon reception of the update notification of the configuration from the configuration transmitting/receiving module, the configuration managing module 13 reads out the configuration 14 (S131), sets the updated filter rule to the filtering module (S133), reflects the other setting items if there is any (S134), and instructs the frame transfer module 15 to start the frame transfer (S135).

FIG. 23 is a sequence diagram of another configuration synchronization processing between the new switch 1 and the existing switch 2A according to the second embodiment.

The configuration synchronization processing shown in FIG. 23 synchronizes the configurations upon linkup. To be specific, when the new switch 1 and the existing switch 2A are connected to each other through a cable, the line interface transits to the active status. Upon the transition to the active status, the configuration is synchronized between the new switch 1 and the existing switch 2A.

When the new switch 1 is activated by power-on (2021), the new switch 1 checks if there are any active ports (2022). As a result, when there is no active port, the new switch 1 gets into the standby status.

When the new switch 1 in the standby status and the existing switch 2A are connected to each other (2023 and 2024), the new switch 1 detects the transition of the line interface to the active status. Then, the new switch 1 transmits the configuration request message 71 to the existing switch 2A through the port that has transited to the active status.

Upon reception of the configuration request message 71 from the new switch 1, the existing switch 2A reads out the configuration 24 to create a configuration notification message 72 that includes the readout configuration. Then, the existing switch 2A returns the created configuration notification message 72 to the new switch 1 as a response to the configuration request message 71.

The new switch 1 receives the configuration notification message 72 to obtain the configuration set in the existing switch 2A. The new switch 1 updates the configuration of the self apparatus with the obtained configuration. In addition, the new switch 1 extracts the filter setting from the configuration notification message 72 to update the filter setting (2025).

Upon termination of the filter setting, the new switch 1 applies the updated filter rule to start the frame transfer (2026). The configurations of the new switch 1 and the existing switch 2A in the configuration synchronization processing shown in FIG. 23 are the same as those described above in FIG. 21. The configuration transmitting/receiving module 11 of the new switch 1 operates in the same manner as in the case of the configuration synchronization processing (FIG. 15) according to the first embodiment. To be specific, the configuration transmitting/receiving module 11 designates the port that has transited to the active status (S111), and transmits the configuration request message 71 through the designated port (S112). Then, upon reception of the configuration notification message 72 from the existing switch 2A (S114), the configuration transmitting/receiving module 11 updates the configuration 14 (S115) and notifies the configuration managing module 13 of the update of the configuration 14 (S116).

The configuration transmitting/receiving module 21 of the existing switch 2A operates in the same manner as in the case of the configuration transmission processing shown in FIG. 19 according to the first embodiment. To be specific, upon reception of the configuration request message 71, the configuration transmitting/receiving module 21 reads out the configuration 24 (S141), creates the configuration notification message containing the readout configuration (S142), and transmits the configuration notification message 72 (S143).

Moreover, the configuration managing module 13 of the new switch 1 operates in the same manner as the configuration transmission processing shown in FIG. 17 according to the first embodiment. To be specific, upon reception of the update notification of the configuration from the configuration transmitting/receiving module 11, the configuration managing module 13 reads out the configuration 14 (S131), sets the updated filter rule to the filtering module (S133), and instructs the frame transfer module 15 to start the frame transfer (S135).

As described above, for the switch 1 according to the second embodiment, the configuration is notified from the existing switch 2A to the new switch 1 upon activation of the new switch 1. As a result, the filter setting can be synchronized upon activation. Moreover, by notifying the configuration from the existing switch 2 to the new switch 1 upon linkup, the filter setting can be synchronized not only upon activation but also after the start of operation. By synchronizing the filter settings upon activation and after the start of operation, the filter settings of the new switch 1 can be synchronized at an arbitrary time point to prevent the security from being lowered.

### Third Embodiment

A switch according to a third embodiment of this invention can not only describe the instruction of the configuration synchronization with the neighboring switch in the configuration as described above but also instruct the configuration synchronization from the input/output device 104 on the existing switch side after the connection of the new switch to the existing switch. Therefore, the security setting and the operation management setting can be synchronized between the existing switch and the new switch.

In the third embodiment, since the switch configuration is the same as that of the first embodiment described above except for differences described below, the same components are denoted by the same reference numerals and the description thereof is herein omitted.

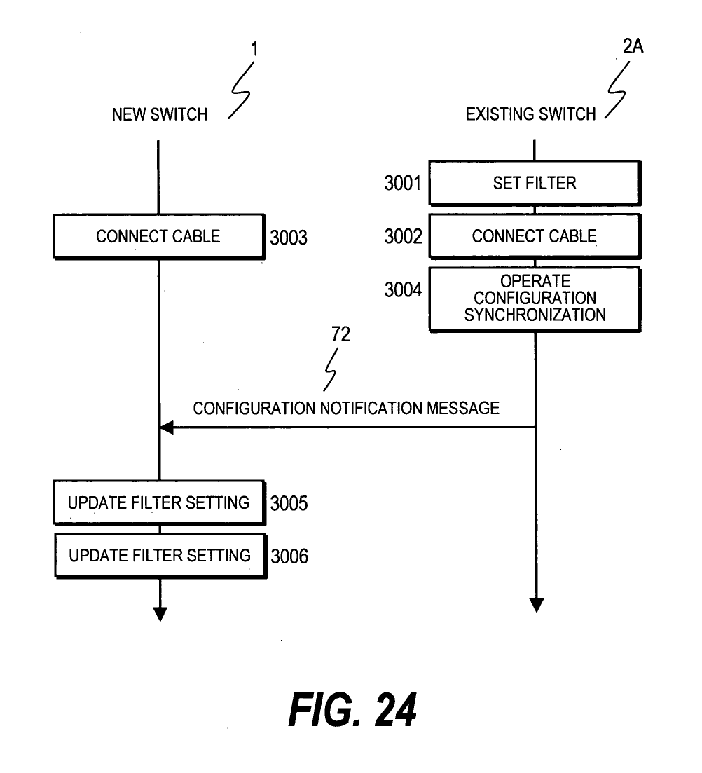

FIG. 24 is a sequence diagram of a configuration synchronization processing between the new switch 1 and the existing switch 2A according to the third embodiment.

The filter rule is set for the existing switch 2A (3001), and the existing switch 2A is operating in the network 5.

After that, for the expansion of the network, an administrator connects the existing switch 2A and the new switch 1 to each other through a cable (3002 and 3003).

After that, when the administrator instructs the configuration request through the input/output device 104 of the existing switch 2A (3004), the existing switch 2A reads out the configuration 24 to create the configuration notification message 72 that includes the readout configuration. Then, the existing switch 2A transmits the created configuration notification message 72 to the new switch 1 as a response to the configuration request message 71.

The new switch 1 receives the configuration notification message 72 to obtain the configuration set in the existing switch 2A. The new switch 1 updates the configuration of the self apparatus with the obtained configuration. In addition, the new switch 1 extracts the filter setting from the configuration notification message 72 to update the filter setting (3005).

Upon termination of the filter setting, the new switch 1 applies the updated filter rule to start frame transfer (3006).

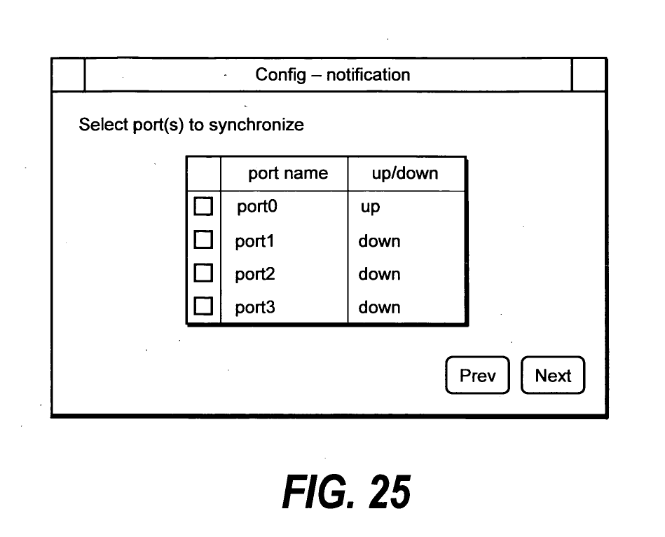

FIG. 25 is an explanatory view which instructs the new switch to synchronize the configuration according to the third embodiment.

The administrator operates the input/output device 104 of the existing switch 2A to designate a port for which the configuration synchronization is executed through the setting screen. On the setting screen, a name of each of the ports included in the existing switch 2A and a link status between the port and the neighboring switch are displayed. The administrator designates a port, to which the new switch 1 whose configuration is to be synchronized with that of the existing switch 2A is connected, among a plurality of ports displayed on the setting screen.

Since the administrator can confirm a link status for each port displayed on the setting screen, the administrator can easily grasp the port used for the connection between the new switch 1 and the existing switch 2. Therefore, the administrator can reduce errors in operation for designating the port whose configuration is to be synchronized.

The input/output device 104 displays the result of checking the appropriateness of the port number (validity/invalidity and active/inactive status of the port). When the port is valid and active, the input/output device 104 displays the success or failure of the configuration synchronization via the port.

The input/output device 104 can also be configured to allow the administrator to designate the port used for configuration synchronization through a command line interface. In this case, the administrator inputs command strings indicating the configuration synchronization and a used port number.

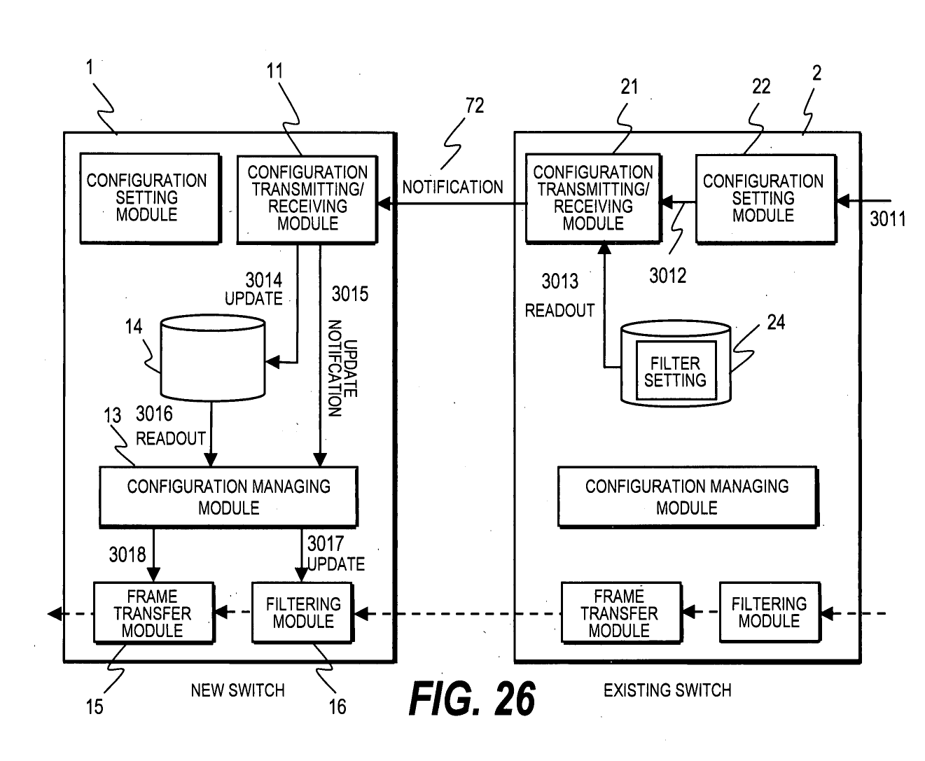

FIG. 26 is an explanatory view of the configuration synchronization processing according to the third embodiment, illustrating the communication of a message in the switch and between the switches when the existing switch 2A instructs the configuration synchronization.

First, the administrator inputs a configuration synchronization instruction to the input/output device on the existing switch 2 side while the new switch 1 and the existing switch 2A are being connected to each other (3011).

Upon reception of the configuration synchronization instruction input by the administrator, a configuration setting module 22 transmits the configuration synchronization instruction to the configuration transmitting/receiving module 21 (3012).

Upon reception of the configuration synchronization instruction input by the administrator, the configuration transmitting/receiving module 21 analyzes a used port number contained in the received synchronization instruction. Then, the configuration transmitting/receiving module 21 checks the validity and the active status of the port of the analyzed number. Then, when the port is available, the configuration transmitting/receiving module 21 reads out the content of the configuration 24 (3013) to create the configuration notification message 72 that includes the content of the configuration 24. Then, the configuration transmitting/receiving module 21 transmits the created configuration notification message 72 to the new switch 1.

Upon reception of the configuration notification message 72 from the existing switch 2, the configuration transmitting/receiving module 11 of the new switch 1 extracts the configuration from the received message to update the configuration 14 of the self apparatus with the content of the extracted configuration (3014). After that, the configuration transmitting/receiving module 11 notifies the configuration managing module 13 of the update of the configuration (3015).

Upon reception of the update notification of the configuration from the configuration transmitting/receiving module 11, the configuration managing module 13 reads out the configuration 14 in the self apparatus (3016) to apply the updated filter rule to the filtering module 16 (3017). After that, the configuration managing module 13 instructs the frame transfer module 15 to start the frame transfer (3018).

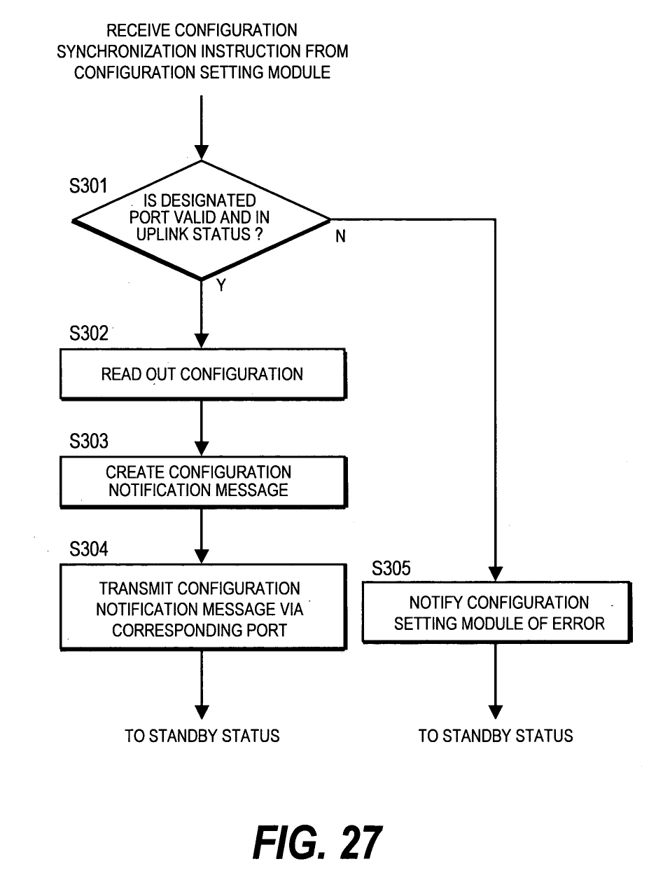

FIG. 27 is a flowchart of the configuration transmission processing according to the third embodiment, the processing being executed in the configuration transmitting/receiving module 21 when the configuration synchronization is instructed from the existing switch 2A side.

Upon reception of the configuration synchronization instruction input by the administrator, the configuration transmitting/receiving module 21 of the existing switch 2A analyzes the content of the received instruction to extract a port number. Then, the configuration transmitting/receiving module 21 checks whether or not a port of the number designated by the administrator is valid, in the active status, and in an uplink status or a downlink status.

As a result, when the designated port is valid, active, and in the uplink status, the configuration transmitting/receiving module 21 reads out the configuration 24 (S302). Then, the configuration transmitting/receiving module 21 creates the configuration notification message 72 that includes the readout content in its configuration field (S303). Then, the configuration transmitting/receiving module 21 returns the thus created configuration notification message 72 from the corresponding port (S304) to return to the standby status.

On the other hand, when the designated port is invalid, is not active, or is in a downlink status, the configuration transmitting/receiving module 21 notifies the configuration setting module 22 of an error (S305).

As described above, since the switch according to the third embodiment can instruct the configuration synchronization from the input/output device of the existing switch 2A, the configuration can be synchronized between the new switch 1 and the existing switch 2A not only upon activation of the switch but also after the activation.

Moreover, since the port used for the configuration synchronization is set from the input/output device 104, the administrator can limit a destination of the transmission of the configuration notification message 72 only to the new switch. In this manner, the configuration notification message 72 is never transmitted to the plurality of switches and terminals connected to the existing switch 2A. As a result, unnecessary spread of the security setting and the operation management setting can be prevented to enhance the security in network operation.

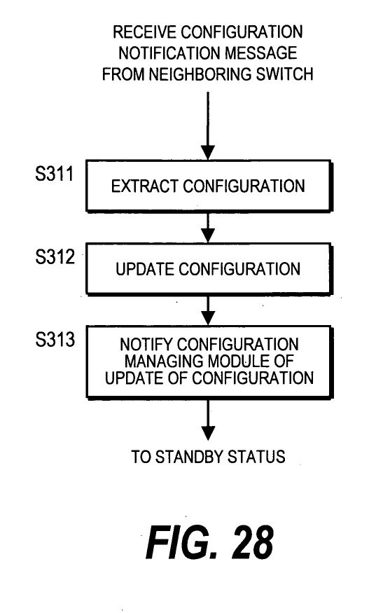

FIG. 28 is a flowchart of the configuration synchronization processing according to the third embodiment, the processing being executed in the configuration transmitting/receiving module 11.

Upon reception of the configuration notification message 72 from the neighboring switch 2A (S311), the configuration transmitting/receiving module 11 analyzes the configuration field in the configuration notification message 72 to update the configuration 14 of the new switch 1 with the content of the notified configuration (S312). After that, the configuration transmitting/receiving module 11 notifies the configuration managing module 13 of the update of the configuration (S313). Then, the configuration transmitting/receiving module 11 terminates the configuration synchronization processing to return to the standby status.

### Fourth Embodiment

The switch according to a fourth embodiment of this invention grasps a setting status of each of the configurations to synchronize the configurations when the configuration is notified from the existing switch to the new switch upon linkup.

In the forth embodiment, since the switch configuration is the same as that of the first embodiment described above except for differences described below, the same components are denoted by the same reference numerals and the description thereof is herein omitted.

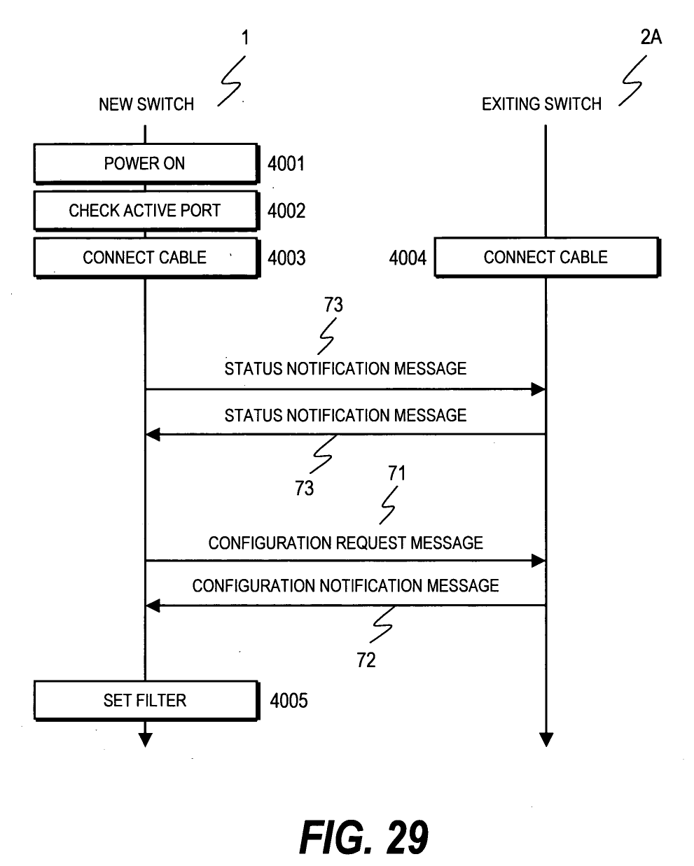

FIG. 29 is a sequence diagram of a configuration synchronization processing between the new switch 1 and the existing switch 2A according to the fourth embodiment.

When the new switch 1 is activated by power-on (4001), the new switch 1 checks if there are any active ports (4002). As a result, when there is no active port, the new switch 1 gets into the standby status.

When the new switch 1 in the standby status and the existing switch 2A are connected to each other (4003 and 4004), the new switch 1 detects the transition of the line interface to the active status. Then, the new switch 1 transmits the status notification message 73 to the existing switch 2A through the port that has transited to the active status.

Upon reception of a status notification message 73 from the new switch 1, the existing switch 2A returns the status of the self apparatus as another status notification message 73 to the new switch 1. By the exchange of the status notification messages 73, the new switch 1 and the existing switch 2A grasp the statuses of their configurations.

Upon reception of the status notification message 73, the new switch 1 checks the setting status of the new switch 1 and the setting status of the existing switch 2A. When the new switch 1 is in an unset status and the existing switch 2A is in a set status, the new switch 1 transmits the configuration request message 71 to the existing switch 2A via the corresponding port.

Upon reception of the configuration request message 71 from the new switch 1, the existing switch 2A reads out a configuration 24 to create a configuration notification message 72 that includes the readout configuration. Then, the existing switch 2A returns the created configuration notification message 72 to the new switch 1 as a response to the configuration request message 71.

The new switch 1 receives the configuration notification message 72 to obtain the configuration set in the existing switch 2A. The new switch 1 updates the configuration of the self apparatus with the obtained configuration. In addition, the new switch 1 extracts the filter setting from the configuration notification message 72 to update the filter setting (4005).

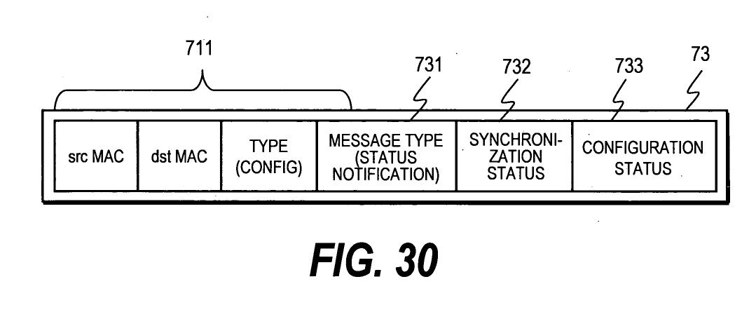

FIG. 30 is an explanatory view of a format of the status notification message 73 according to the fourth embodiment.

The status notification message 73 contains the header 711, a message type field 731, a synchronization status field 732, and a configuration status field 733.

A destination address field in the header 711 includes an MAC address of the switch corresponding to the destination of the status notification. A source address field in the header 711 includes an MAC address of the switch corresponding to the source of the status notification. A Type field in the header 711 includes an identifier indicating that the message is used for the configuration synchronization processing according to the fourth embodiment.

The message type field 731 includes an identifier indicating that the message is for status notification.

The synchronization status field 732 includes a synchronization status with the destination switch of the message.

The configuration status field 733 includes a setting status of the configuration of the self apparatus. To be specific, for transmission of the status notification message 73, a flag in an unset status is set when the switch is in an initial status and is still being activated (specifically, when the configuration is not set). When the configuration has already been set, a flag in the set status is set.

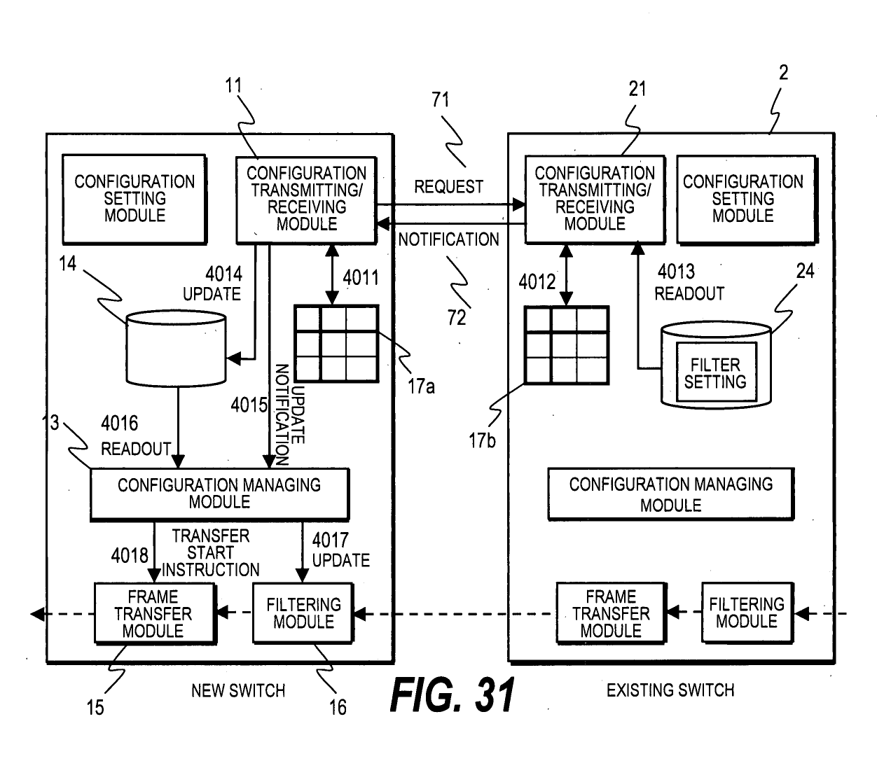

FIG. 31 is an explanatory view of the configuration synchronization processing according to the fourth embodiment, illustrating the communication of a message in the switch and between the switches when the configurations are synchronized according to a synchronization status of the switch.

The new switch 1 according to the fourth embodiment includes a synchronization status management table 17a. The existing switch 2A includes a synchronization status management table 17b. The synchronization status management tables 17a and 17b are stored in memories of the respective switches.

When the new switch 1 is activated to establish a link with the neighboring switch, the configuration transmitting/receiving module 11 reads out a synchronization status from the synchronization status management table 17a (4011) to create the status notification message 73. Then, the configuration transmitting/receiving module 11 transmits the thus created status notification message 73 to the neighboring existing switch 2A via the linkup port.

Upon reception of the status notification message 73 from the new switch 1, the configuration transmitting/receiving module 21 of the existing switch 2 reads out a synchronization status from the synchronization status management table 17b (4012) to create the status notification message 73. Then, the configuration transmitting/receiving module 21 returns the thus created status notification message 73 to the new switch 1.

Upon reception of the status notification message 73, the new switch 1 judges the statuses of the self apparatus and the neighboring apparatus. As a result, when the new switch 1 is in the unset status and the existing switch 2A is in the set status, the new switch 1 transmits the configuration request message 71 to the configuration transmitting/receiving module 21 of the existing switch 2.

Upon reception of the configuration request message 71 from the new switch 1, the configuration transmitting/receiving module 21 of the existing switch 2 reads out the content of the configuration 24 (4013) to create the configuration notification message 72 that includes the content of the configuration 24. Then, the configuration transmitting/receiving module 21 returns the created configuration notification message 72 to the new switch 1.

Upon reception of the configuration notification message 72 from the existing switch 2, the configuration transmitting/receiving module 11 of the new switch 1 extracts the configuration from the received message to update the configuration 14 of the self apparatus based on the content of the extracted configuration (4014). After that, the configuration transmitting/receiving module 11 notifies the configuration managing module 13 of the update of the configuration (4015).

Upon reception of the update notification of the configuration from the configuration transmitting/receiving module 11, the configuration managing module 13 reads out the configuration 14 in the self apparatus (4016) to apply the updated filter rule to the filtering module 16 (4017). After that, the configuration managing module 13 instructs the frame transfer module 15 to start the frame transfer (4018).

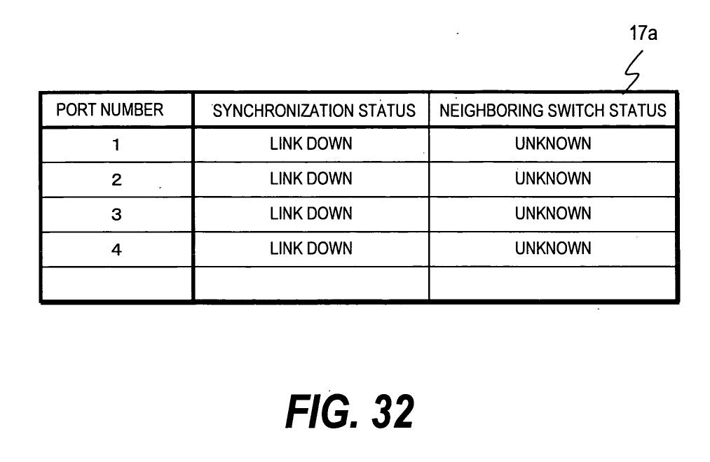

FIG. 32 is an explanatory view of the synchronization status management table 17a according to the fourth embodiment.

Although the synchronization status management table 17a included in the new switch 1 will be described, the configuration of the synchronization status management table 17b included in the existing switch 2A is the same.

The synchronization status management table 17a contains a port number, a synchronization status, and a status of the neighboring switch.

The port number is a number of the port provided for the switch 1. The synchronization status is a synchronization status of the configuration with the neighboring switch connected to the corresponding port. The status of the neighboring switch is a set status of the configuration of the connected neighboring switch.

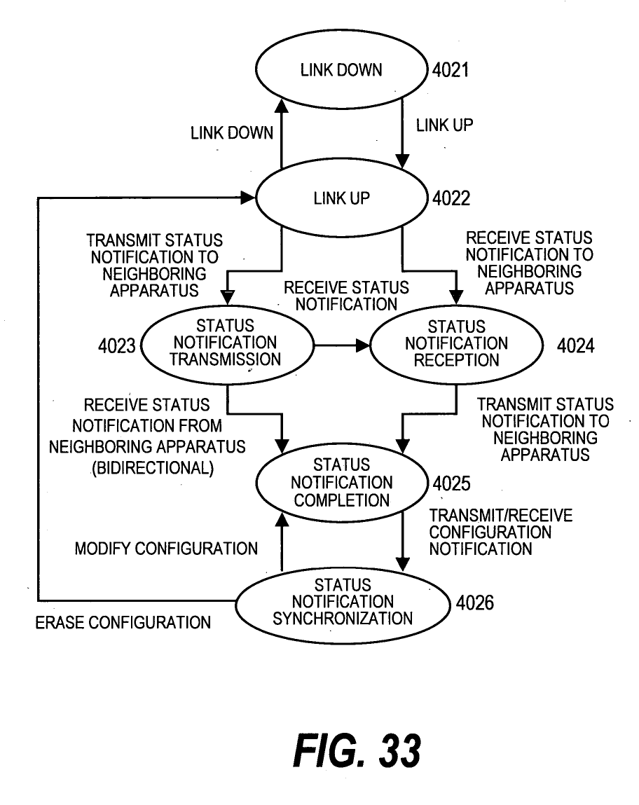

FIG. 33 is an explanatory view of a transition of the synchronization status according to the fourth embodiment. The synchronization status shown in FIG. 33 is stored in the “synchronization status” field in the synchronization status management tables 17a and 17b.

In the fourth embodiment, the switch 1 has six synchronization statuses, specifically, link down 4021, link up 4022, status notification reception 4023, status notification transmission 4024, status notification completion 4025, and configuration synchronization 4026. The status is judged for each port.

The link down status 4021 is a status where nothing is connected to the port or the port is set to be inactive by the input/output device 104. The link up status 4022 is a status where the line interface is active.

The status notification reception status 4023 is a status where the status notification message is received from the neighboring switch but the status notification message is not transmitted. The status notification transmission status 4024 is a status where the status notification message is transmitted to the neighboring switch but the status notification message is not received.

The status notification completion status 4025 is a status where the transmission and the reception of the status notification message with the neighboring switch are completed. The configuration synchronization status 4026 is a status where the configuration synchronization is completed.

When the neighboring switch is connected to the port of the configuration transmitting/receiving module 11 in the link down status 4021 to bring the line interface into an active status, the status of the port transits to the link up status 4022.

When the port transits to the link up status 4022, the switch according to the fourth embodiment transmits the status notification message 73 that includes the setting status of the configuration of the self apparatus to the neighboring switch via the port after a predetermined waiting time. After the transmission of the status notification message 73, the status of the port transits to the status notification transmission status 4023.

Upon reception of the status notification message 73 from the neighboring switch via the port after the transmission of the status notification message 73, the status of the port transits to the status notification completion status 4025.

When the port, which has transited to the link up status, receives the status notification message 73 from the neighboring switch before transmitting the status notification message 73, the status of the port transits to the status notification reception status 4024.

Upon transition of the port status to the status notification reception status 4024, the port returns the status notification message 73 containing the setting status of the configuration of the self apparatus to the neighboring switch. Then, after the transmission of the status notification message 73, the status of the port transits to the status notification completion status 4024.

If there is any port that has transited to the status notification completion status 4024, the neighboring switch connected to the port and the switch mutually grasp the setting statuses of their own configurations. The port operates in the following manner according to the setting statuses of the configurations of the self apparatus and the neighboring switch.

When both the self apparatus and the neighboring switch are in the unset status or in the set status, the status of the port transits from the status notification completion status 4024 to the configuration synchronization status 4025.

When the self apparatus is in the unset status whereas the neighboring switch is in the set status, the self apparatus transmits the configuration request message 71 to the neighboring switch. As a response to the configuration request message 71, the self apparatus receives the configuration notification message 72 from the neighboring switch. The self apparatus analyzes the configuration notification message 72 to modify the configuration of the self apparatus. Then, the status of the port transits from the status notification completion status 4024 to the configuration synchronization status 4025.

When the self apparatus is in the set status whereas the neighboring switch is in the unset status, the self apparatus waits for the configuration request message 71 from the neighboring switch and transmits the configuration notification message 72 as a response to the configuration request message 71. Then, after the neighboring switch modifies the configuration based on the content of the configuration notification message 72, the status of the port transits from the status notification completion status 4024 to the configuration synchronization status 4025.

When the configuration is deleted after the synchronization of the configuration with the neighboring switch, the statuses of all the link-up ports transit from the configuration synchronization status 4025 to the link up status 4022. The status is equivalent to that in the case where the self apparatus is connected to the existing apparatus in the initial status. Since the configuration is set in the neighboring switch, the self apparatus transmits/receives the status notification message 73, the configuration request message 71, and the configuration notification message 72 to/from the neighboring switch again to synchronize the configuration.

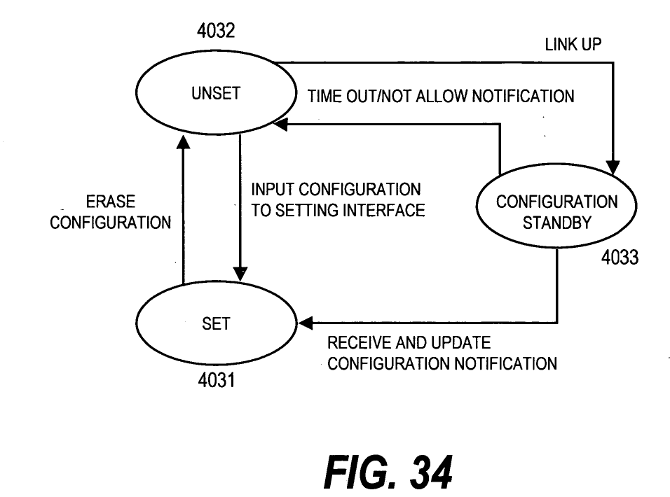

FIG. 34 is an explanatory view of a transition of the setting status according to the fourth embodiment. The synchronization status shown in FIG. 33 is stored in the “neighboring switch status” field in the synchronization status management tables 17a and 17b.

The switch in the unset status transits to a set status 4031 by the notification 72 of the configuration from the neighboring switch or the setting of the configuration from the input/output device 104. The switch in the set status 4031 transits to an unset status 4032 by deleting the configuration.

The switch whose port is in the link up status and is waiting for the configuration from the neighboring switch is brought into a configuration standby status 4033. Upon reception of the notification 72 of the configuration, the switch in the configuration standby status 4033 transits to the set status 4031. Upon timeout or non-allowance of the notification, the switch transits to the unset status 4032.

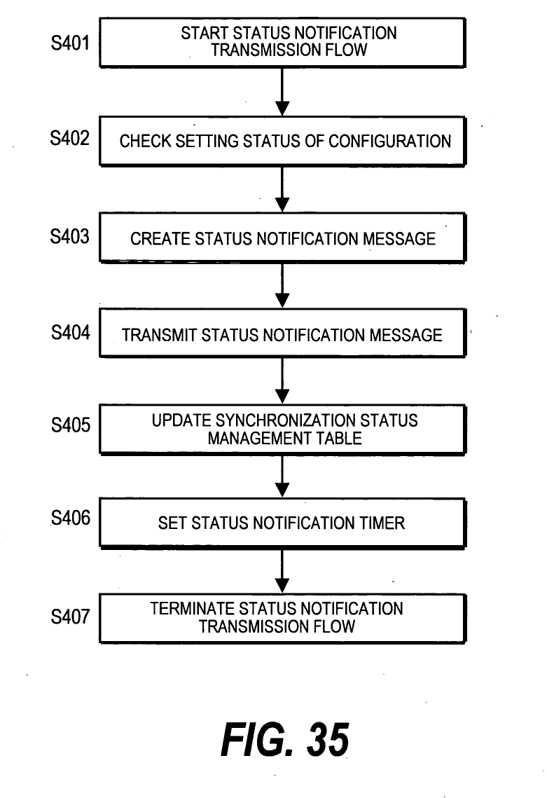

FIG. 35 is a flowchart of a status notification transmission processing according to the fourth embodiment, the processing being executed in the configuration transmitting/receiving modules 11 and 21.

Upon link up of the port of the self apparatus, the new switch 1 and the existing switch 2A start the status notification transmission processing (S401).

First, the synchronization status management table 17a or the like is referred to so as to check the setting status of the configuration of the self apparatus (S402). Then, each of the configuration transmitting/receiving modules 11 and 12 stores the setting status and creates a status notification message in which the synchronization status is set to the link down status (S403).

Each of the configuration transmitting/receiving modules 11 and 12 transmits the status notification message via the link-up port (S404). Then, the synchronization status of the port, which is stored in the synchronization management table 17a or the like, is updated to the status notification transmission status (S405).

Ultimately, a status notification timer is set (S406). By the status notification timer, a standby time for the reception of the status notification from the neighboring switch is determined.

To be specific, the configuration transmitting/receiving modules 11 and 21 in the standby status wait for the reception of the status notification from the neighboring switch during the operation of the status notification timer. After that, upon expiration of the status notification timer, the configuration transmitting/receiving modules 11 and 21 start the status notification processing again to transmit the status notification message 73 via the link-up port. As a result, when the status notification is not received from the neighboring switch that has transmitted the status notification, the self apparatus notifies the neighboring switch of its setting status again.

After that, the configuration transmitting/receiving modules 11 and 21 return to the standby status to terminate the status notification transmission flow (S407).

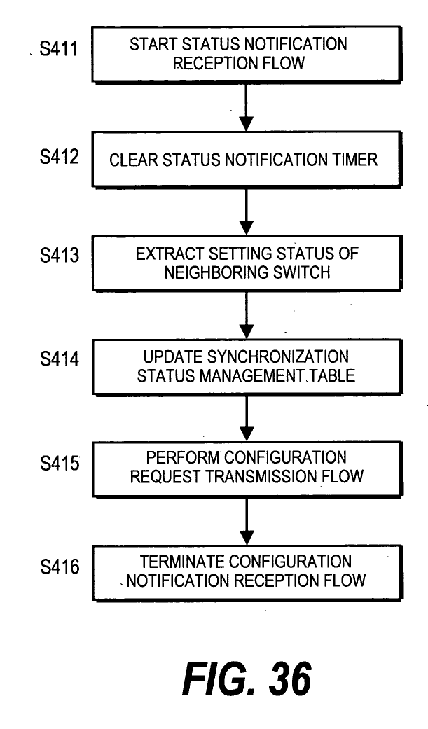

FIG. 36 is a flowchart of a status notification reception processing according to the fourth embodiment, the processing being executed in the configuration transmitting/receiving modules 11 and 21.

Upon reception of the status notification message 73 from the neighboring switch, the new switch 1 and the existing switch 2A start the status notification reception flow (S411).

First, when the status notification timer is set for the port that has received the status notification message 73, the status notification timer is cleared (S412).

Subsequently, the received status notification message is analyzed to extract the setting status of the neighboring switch from the status notification message (S413). Then, the setting status of the configuration of the neighboring switch is reflected on the synchronization status management table (S414).

After that, the configuration request transmission processing is executed to judge whether or not to transmit the configuration request message to the neighboring switch (S415). After that, the configuration transmitting/receiving modules 11 and 21 return to the standby status to terminate the status notification reception flow (S416).

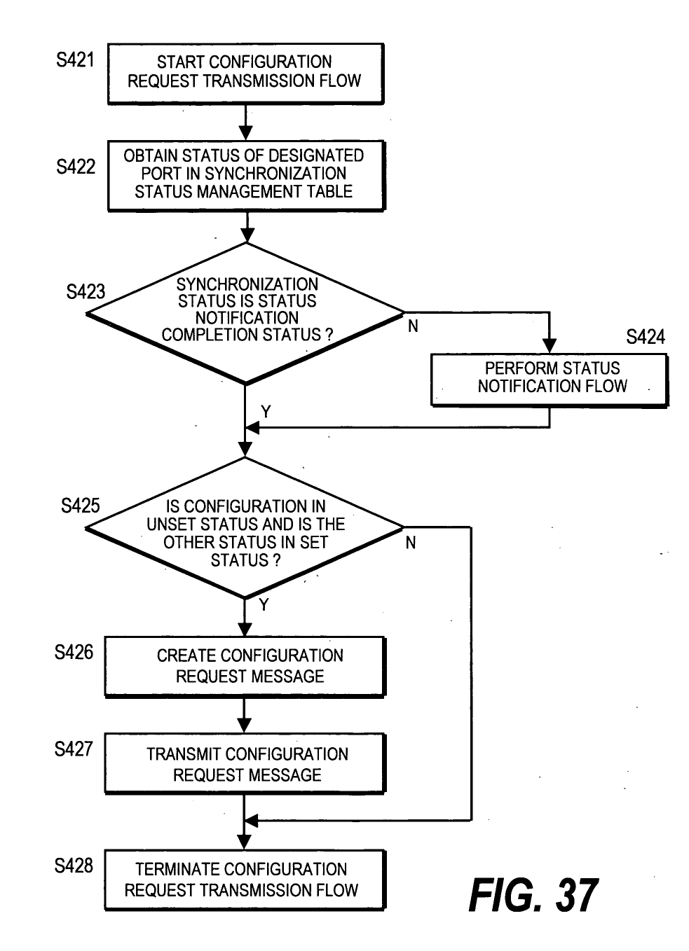

FIG. 37 is a flowchart of a configuration request processing according to the fourth embodiment, the processing being executed in the configuration transmitting/receiving modules 11 and 12.

Subsequent to the update of the synchronization management table 17a or the like upon reception of the status notification message 73, the new switch 1 and the existing switch 2A start the configuration request transmission processing.

The synchronization status of the port that has received the status notification message 73 is obtained from the synchronization status management table 17a or the like (S422).

Then, it is checked whether or not the synchronization status with the neighboring switch is the status notification completion status (S423). As a result, when the synchronization status with the neighboring switch is not the status notification completion status (is the status notification reception status), the status notification transmission processing (FIG. 35) is executed (S424) because the neighboring switch does not recognize the status notification message 73 of the self apparatus.

On the other hand, when the synchronization status with the neighboring switch is the status notification completion status, the setting status of the configuration of the self apparatus and that of the neighboring switch are compared with each other because the self apparatus and the neighboring switch have already exchanged the status notification message 73 (S425).

As a result, when the self apparatus is in the unset status and the neighboring switch is in the set status, the configuration request message 71 is created (S426). Then, the thus created configuration request message 71 is transmitted to the neighboring switch (S427).

Upon reception of the configuration notification message 72 in response to the configuration request message 71, the configuration transmitting/receiving module 11 of the new switch 1 synchronizes the configuration to synchronize the filter setting, in the same manner as described above. The configuration managing module 13 of the new switch 1 updates the filter rule based on the updated configuration in the same manner as described above.

On the other hand, when the self apparatus is not in the unset status or the neighboring switch is not in the set status, the configuration is not synchronized.

After that, the configuration request processing is terminated (S428).

In the fourth embodiment, the case where the new switch is in the unset status and the existing switch is in the set status has been described. By storing detailed status information in the status notification message, the synchronization operation between the new switch and the existing switch can also be finely controlled.

As described above, in the fourth embodiment, through the transmission and reception of the setting status notification message 73, the necessity of synchronization of the configuration between the connected switches is judged. Then, when it is judged that the configuration is required to be synchronized, the configuration is synchronized between the connected switches through the transmission and reception of the configuration request message 71 and the configuration notification message 72.

As a result, the configuration can be set according to the setting status of the switch. Moreover, by automatically applying the management policy and the security policy to the newly introduced apparatus, the management cost with the expansion of the network can be reduced to lower the risk of lowered security.

### Fifth Embodiment

In a fifth embodiment of this invention, the case where the switches whose configurations are synchronized automatically synchronize the filter setting when one of the switches changes the filter setting, will be described.

In the fifth embodiment, the case where a change of the configuration in the existing switch 2A is automatically applied to the new switch 1 will be described.

In the fifth embodiment, since the switch configuration is the same as that of the first embodiment described above except for differences described below, the same components are denoted by the same reference numerals and the description thereof is herein omitted.

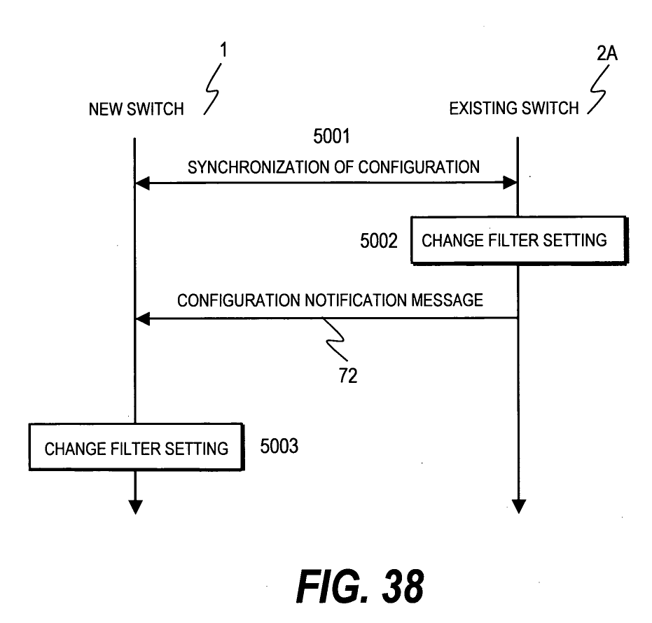

FIG. 38 is a sequence diagram of a configuration synchronization processing between the new switch, and the existing switch 2A according to the fifth embodiment.

The configuration is synchronized between the new switch 1 and the existing switch 2A (5001). After that, the filter setting is changed in the existing switch 2A (5002). For example, a filter rule for discarding different types of packets is added.

When the filter setting is changed in the existing switch 2A, the existing switch 2A transmits the configuration notification message 72 to the new switch 1. The configuration notification message 72 contains the description of the added filter rule.

The new switch 1 analyzes the configuration notification message 72 received from the existing switch 2A to add the added filter rule to the self apparatus (5003).

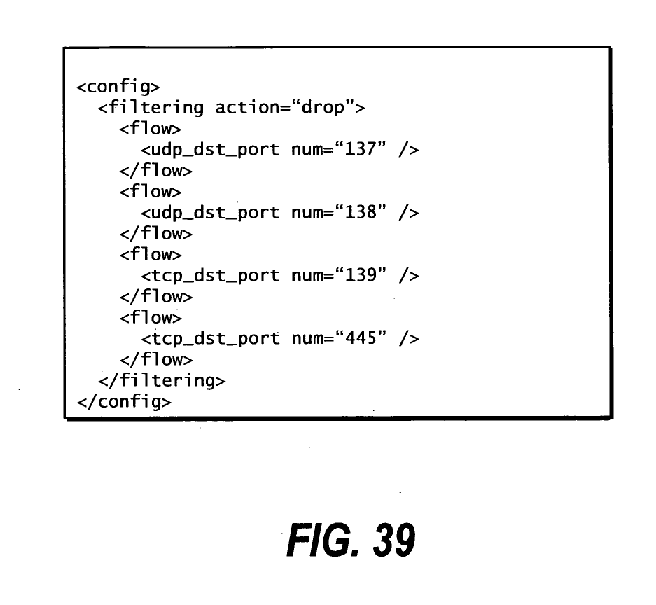

FIG. 39 is an explanatory view of the configuration field 721 in the configuration notification message 72 according to the fifth embodiment, illustrating the content of the configuration field 721 in the configuration notification message 72 notified from the existing switch 2A to the new switch 1 upon update of the filter setting in the existing switch 2A.

In addition to the configuration field 721 described with reference to FIG. 7, the configuration field 721 shown in FIG. 39 also describes setting for discarding a TCP packet with a destination port number 445 in a <flow> element.

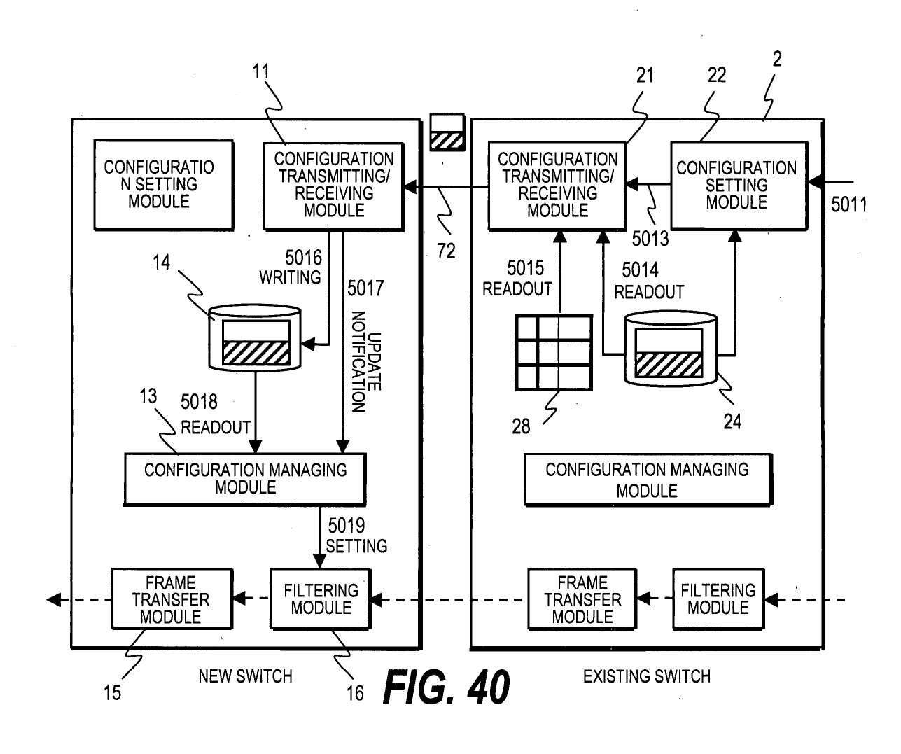

FIG. 40 is an explanatory view of the configuration synchronization processing according to the fifth embodiment, illustrating the communication of a message in the switch and between the switches when the filter setting in the existing switch 2A is changed.

The existing switch 2A according to the fifth embodiment includes a configuration notification management table 28. The configuration notification management table 28 is stored in the memory of the existing switch 2A and is used for looking up the port that has transmitted the configuration notification message 72.

While the configuration of the new switch 1 and that of the existing switch 2A are synchronized with each other, the administrator instructs a change of the filter setting through the input/output device 204 of the existing switch 2A (5011).

The configuration setting module 22 updates the configuration 24 in response to the instruction of a change of the setting from the administrator (5012) to notify the configuration transmitting/receiving module 21 of the update of the configuration (5013).

Upon reception of the notification of the configuration update, the configuration transmitting/receiving module 21 reads out the content of the updated configuration 24 (5014) to create the configuration notification message 72 that includes the content of the configuration 24. Next, the configuration transmitting/receiving module 21 reads out the configuration notification management table 28 (5015) to transmit the created configuration notification message 72 via the port having a transmission record of the configuration notification message.

Upon reception of the configuration notification message 72 from the existing switch 2A, the configuration transmitting/receiving module 11 of the new switch 1 extracts the configuration from the received message to update the configuration 14 of the self apparatus based on the content of the extracted configuration (5016). After that, the configuration transmitting/receiving module 11 notifies the configuration managing module 13 of the update of the configuration (5017).

Upon reception of the update notification of the configuration from the configuration transmitting/receiving module 11, the configuration managing module 13 reads out the configuration 14 in the self apparatus (5018) to apply the updated filter rule to the filtering module 16 (5019). To be specific, a TCP packet having a destination port number 445 is added to targets to be discarded.

After that, the configuration managing module 13 uses the updated filter rule to transfer a frame.

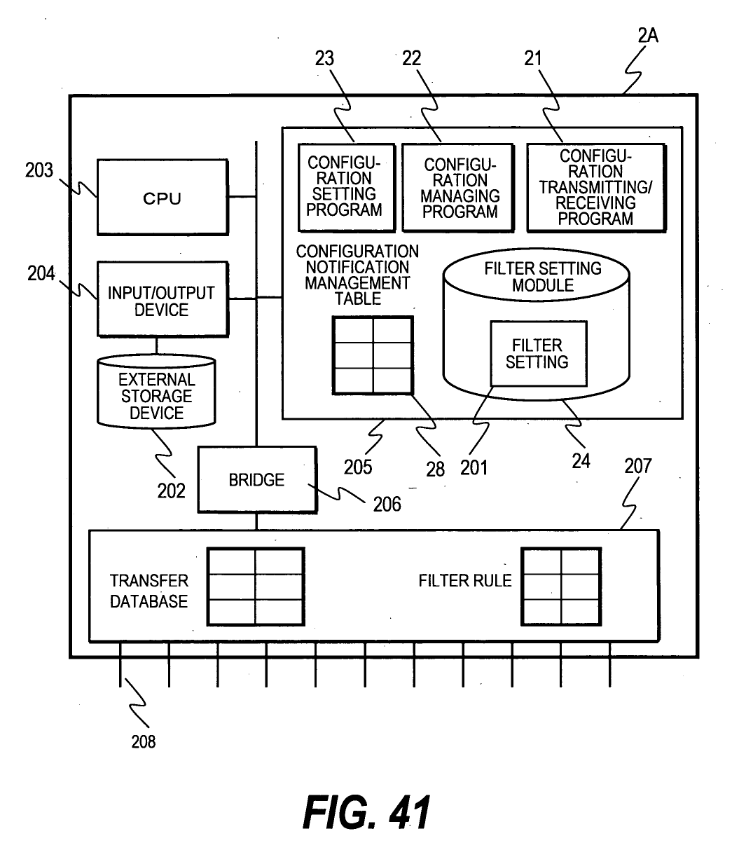

FIG. 41 is a block diagram of the switch 2A according to the fifth embodiment.

The switch 2A includes a CPU 203, an input/output device 204, a memory 205, an external storage device 202, a bridge 206, and a switching module 207. The CPU 203, the input/output device 204, and the memory 205 are connected to each other through an internal bus.

The CPU 203, the input/output device 204, the external storage device 202, the bridge 206, and the switching module 207 are the same as the corresponding configurations of the switch 1 (FIG. 9) according to the first embodiment described above.

The memory 205 stores various programs executed in the CPU and data. To be specific, a configuration transmitting/receiving program 21, a configuration setting program 22, a configuration managing program 23, the configuration 24, and the configuration notification management table 28 are stored. The configuration 24 includes a filter setting 201.

The configuration notification management table 28 includes a transmission history of the configuration notification message 72 from each port, as shown in FIG. 43.

The other configurations stored in the memory 205 are the same as the corresponding configurations of the switch 1 (FIG. 9) in the first embodiment described above.

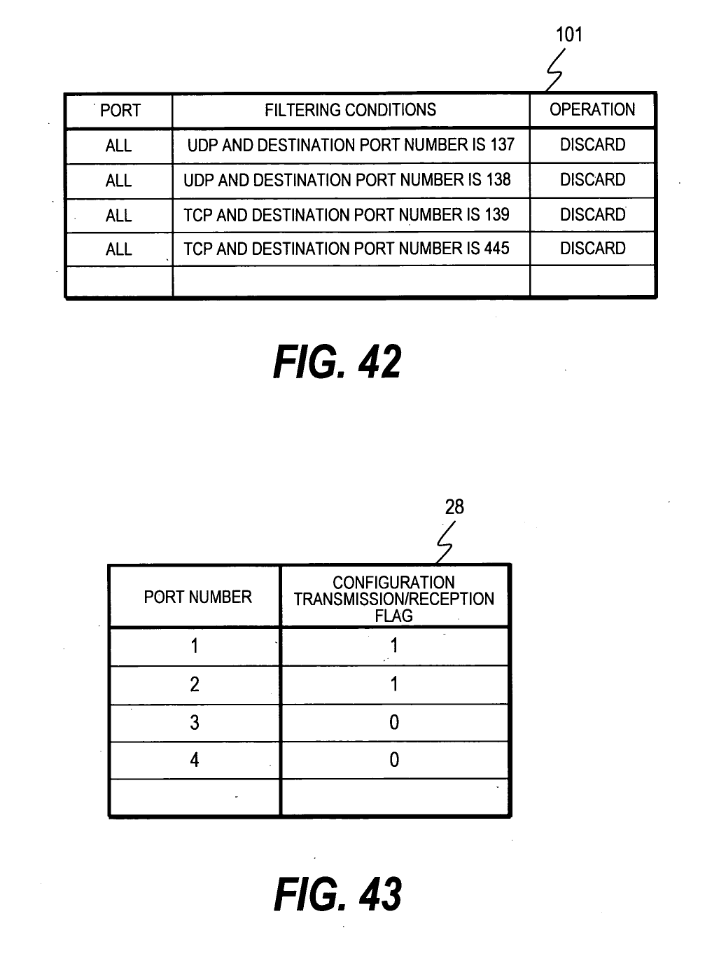

FIG. 42 is a configuration diagram of the filter rule table 101 according to the fifth embodiment.

The filter rule table 101 is updated by the configuration transmitting/receiving module 11 in response to the received configuration notification message 72. The filter rule table 101 shown in FIG. 42 shows the status after the update of the filter rule.

The filter rule table 101 contains data of a port, filtering conditions, and operation.

The filtering module 16 performs a processing defined in the operation on a frame meeting the filtering conditions according to the filter rule table 101.

To be specific, when the configuration transmitting/receiving module 11 receives the configuration shown in FIG. 7 to notify the configuration managing module 13 of the update of the configuration, the configuration managing module 13 sets the filtering module 16 to discard a UDP packet with a destination port number 137, a UDP packet with a destination port number 138, and a TCP packet with a destination port number 139. In addition, in the fifth embodiment, the filtering module 16 is set to discard the TCP packet with the destination port number 445 in response to the update of the configuration.

FIG. 43 is a configuration diagram of the configuration notification management table 28 according to the fifth embodiment.

The configuration notification management table 28 contains a port number and the transmission/non-transmission of the configuration notification message from the corresponding port to include information of all ports of the switch.

In this case, the configuration notification management table 28 shows that the configuration notification message is transmitted through ports with port numbers 1 and 2 among all the ports provided for the switch, to synchronize the configuration between the neighboring switches.

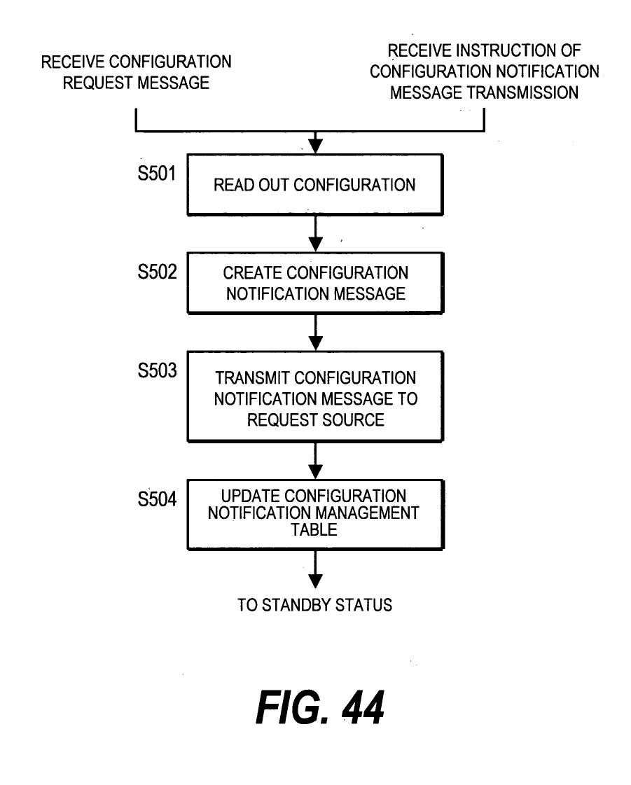

FIG. 44 is a flowchart of the configuration transmission processing according to the fifth embodiment, the processing being executed in the configuration transmitting/receiving module 21 upon initial synchronization of the configuration.

Upon reception of the configuration request message 71 or a configuration notification message transmission instruction from the configuration transmitting/receiving module 11 of the new switch 1, the configuration transmitting/receiving module 21 of the existing switch 2A reads out the configuration 24 (S501).

Then, the configuration transmitting/receiving module 21 creates the configuration notification message 72 which includes the readout content in the configuration field (S502). Then, the configuration transmitting/receiving module 21 transmits the created configuration notification message 72 from a designated port (S503).

After that, the configuration transmitting/receiving module 21 updates a configuration transmission/reception flag of the port, which is included in the configuration notification management table 28, to a “1” (S504). Upon the update, the port that has notified of the configuration is recorded in the table. As a result, when the configuration is updated by the administrator, the port that has to transmit the configuration notification message can be looked up.

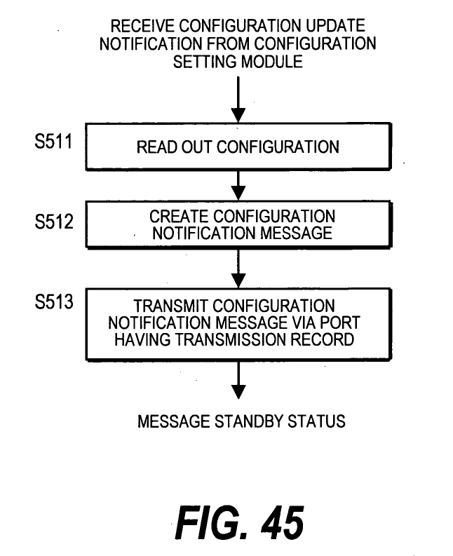

FIG. 45 is a flowchart of the configuration transmission processing according to the fifth embodiment, the processing being executed in the configuration transmitting/receiving module 21 upon modification of the configuration.

Upon reception of a configuration update notification from the configuration setting module 22, the configuration transmitting/receiving module 21 of the existing switch 2A reads out the configuration 24 (S511).

Then, the configuration transmitting/receiving module 21 creates the configuration notification message 72 which includes the readout content in the configuration field (S512). Then, the configuration transmitting/receiving module 21 refers to the configuration notification management table 28 to look up a port used for synchronization of the configuration. Then, the configuration transmitting/receiving module 21 transmits the created configuration notification message 72 from the port having a transmission record of the configuration (S513).

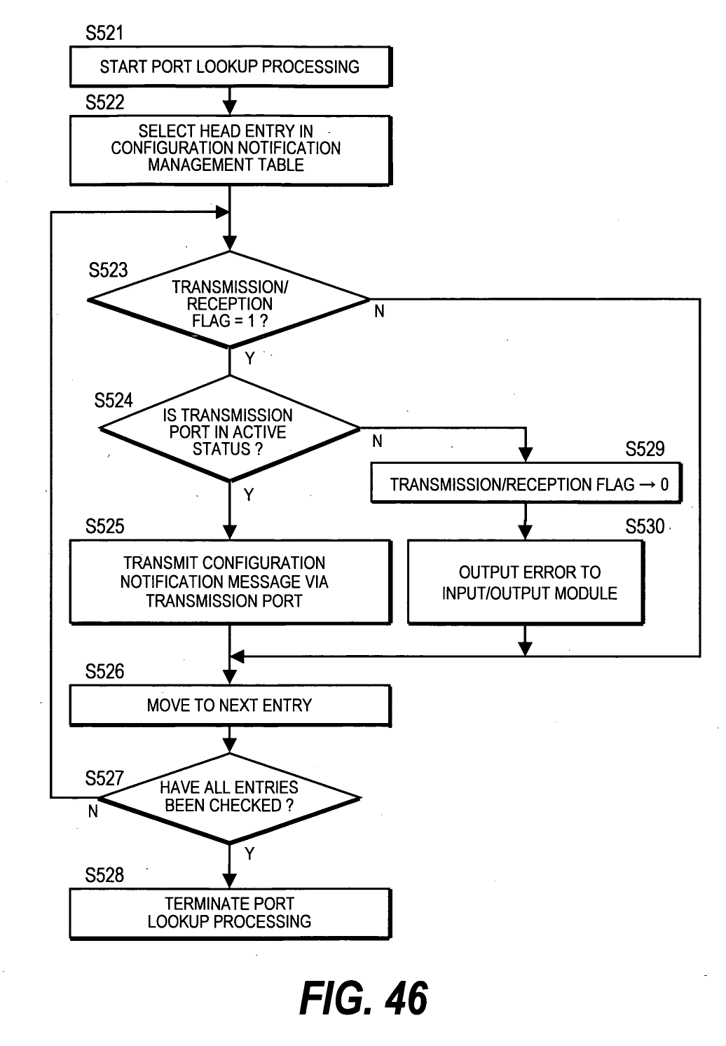

FIG. 46 is a flowchart of a port lookup processing according to the fifth embodiment, the processing being executed by the configuration transmitting/receiving module 21 in Step S513 in FIG. 45.

Upon creation of the configuration notification message 72 based on the reception of the configuration update notification, the port lookup processing is started (S521).

The configuration transmitting/receiving module 21 selects a head entry in the configuration notification management table 28 to read out data in the head entry (S522).

Then, the configuration transmitting/receiving module 21 checks whether the transmission/reception flag of the readout head entry is “1” or not (S523).

As a result, when the transmission/reception flag is not “1”, it is judged that the port has not transmitted the configuration notification message. Then, the configuration transmitting/receiving module 21 proceeds to Step S526 without any processing to move to a next entry.

On the other hand, when the transmission/reception flag is “1”, it is further checked whether the port in the entry is active or not (S524).

As a result, when the checked port is active, the port is determined as a transmission port and the configuration notification message 72 containing the updated content is transmitted to the determined transmission port (S525).

On the other hand, when the transmission/reception flag is “1” and the port is in the inactive status, it is judged that inconvenience has occurred in the connection with the switch connected to the port. Therefore, the configuration transmitting/receiving module 21 sets the transmission/reception flag of the entry to “0” (S529). Furthermore, the configuration transmitting/receiving module 21 outputs an error to the input/output module 204 (S530).

After that, the configuration transmitting/receiving module 21 moves to a next entry (S526).

Then, the configuration transmitting/receiving module 21 checks whether or not all the entries have been checked (S527). When all the entries have been checked, the configuration transmitting/receiving module 21 terminates the port lookup processing to return to the configuration transmission processing (FIG. 45). On the other hand, if any of the entries has not been checked, the configuration transmitting/receiving module 21 returns to Step S523 for further checking.

The configuration transmitting/receiving module 11 of the new switch 1 operates in the same manner as in the case of the configuration synchronization processing (FIG. 28) according to the third embodiment. To be specific, upon reception of the configuration notification message 72, the configuration transmitting/receiving module 11 extracts the configuration from the message (S311), updates the configuration 14 (S312), and notifies the configuration managing module 13 of the update of the configuration (S313).

The configuration managing module 13 of the new switch 1 operates in the same manner as in the case of the configuration update processing (FIG. 17) according to the first embodiment. To be specific, upon reception of the update notification of the configuration from the configuration transmitting/receiving module 11, the configuration managing module 13 reads out the configuration 14 (S131), sets the updated filter rule to the filtering module (S133), and instructs the frame transfer module 15 to start the frame transfer (S135).

As described above, in the fifth embodiment, the switch whose configuration is synchronized upon transmission of the configuration notification message 72 is notified of the update of the configuration, and the updated content of the neighboring switch 1 is updated. As a result, a setting operation by the administrator, which is required for changing the setting of the network, can be reduced. Moreover, the omission of the setting operation due to human error, which becomes a problem when the administrator manually performs the setting operation, can be avoided.

Although the configuration transmitting/receiving module 21 of the existing switch 2A notifies the switch whose configuration is synchronized of the update of the configuration in the fifth embodiment, the configuration notification message 72 may be transmitted through all the active ports upon update of the configuration in the existing switch 2A.

### Sixth Embodiment

A sixth embodiment of this invention is a variation of the fifth embodiment. In this embodiment, the new switch 1 is notified only of an updated part of the configuration from the existing switch 2A to synchronize the security setting and the operation management setting between the switches.

In the sixth embodiment, the new switch 1 confirms the update of the configuration with the existing switch 2A. Only when the configuration is updated, the configuration is synchronized.

In the sixth embodiment, since the switch configuration is the same as that of the fifth embodiment described above except for differences described below, the same components are denoted by the same reference numerals and the description thereof is herein omitted.

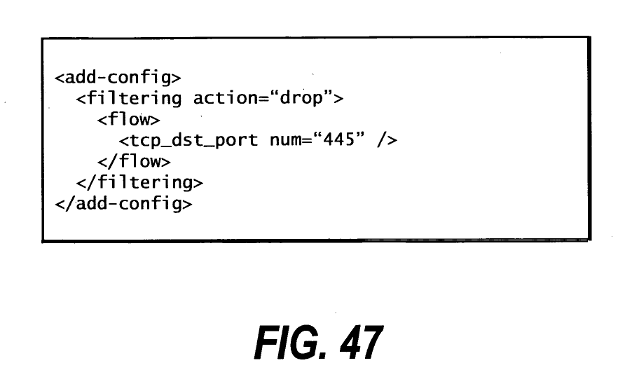

FIG. 47 is an explanatory view of the configuration field 721 in the configuration notification message 72 according to the sixth embodiment, illustrating the content of the configuration notification message notified from the existing switch 2 to the new switch 1 upon update of the filter setting in the existing switch 2A.

An <add-config> element indicates that a description contained in the element corresponds to an updated part of the configuration. The description in the configuration notification field contains a <flow> element that adds the TCP packet with the destination port number 445 to the filtering conditions in the <add-config> element.

Upon reception of the configuration notification message 72 containing a difference in the configuration from the existing switch 2A, the configuration transmitting/receiving module 11 of the new switch 1 adds the <flow> element contained in the configuration notification message to the corresponding part of the configuration 14 and notifies the configuration managing module 13 of the update of the configuration. Upon reception of the update of the configuration, the configuration managing module 13 updates the filtering module 16 based on a new filter rule.

To be specific, by the configuration notification message 72 containing the configuration field 721 shown in FIG. 47, the discard of the TCP packet with the destination port number 445 is added as a filter rule to the already set three filter rules.

As described above, in the sixth embodiment, only the updated part of the configuration is notified from the existing switch 2A to the new switch 1. As a result, traffic for synchronizing the security setting and the operation management setting between the switches can be reduced.

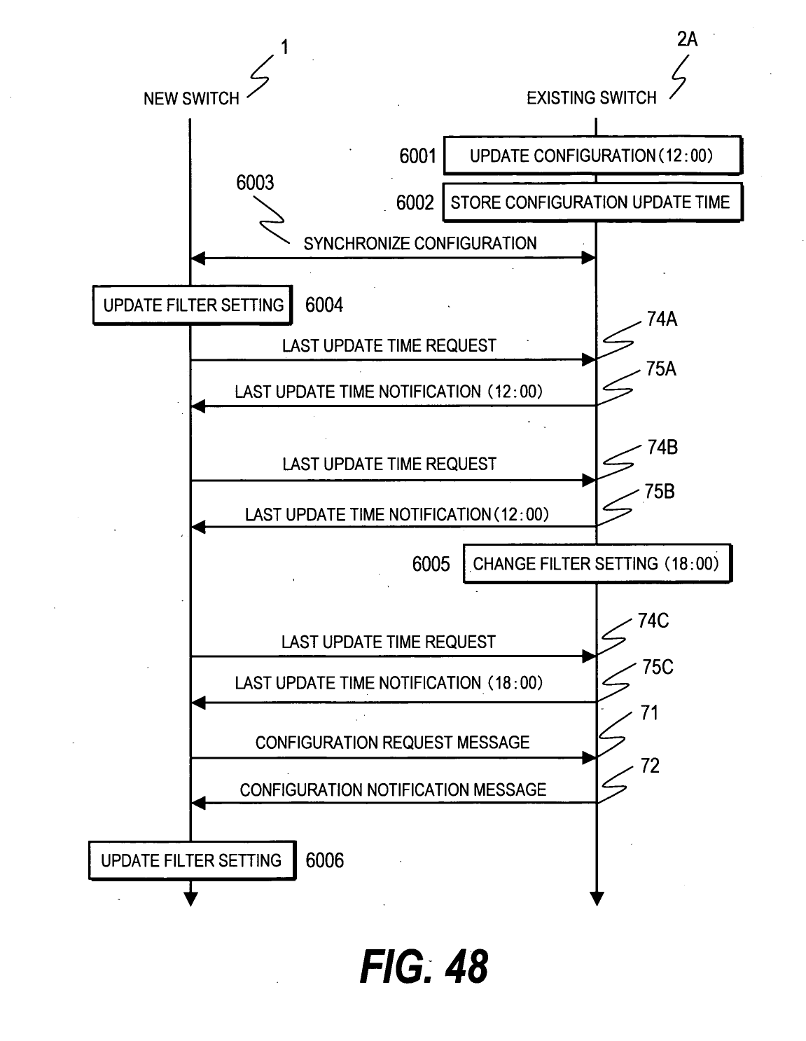

FIG. 48 is a sequence diagram of the configuration synchronization processing between the new switch 1 and the existing switch 2A according to the sixth embodiment, illustrating the case where the new switch 1 polls the confirmation of configuration update.

The configuration of the existing switch 2A is updated at 12:00 (6001). Then, this update time is stored in an update time storage area in the configuration 24 (6002).

After that, the existing switch 2A and the new switch 1 exchange the configuration request message 71 and the configuration notification message 72 to synchronize the configuration (6003). The new switch 1 updates the filter setting (6004).

After the synchronization of the configuration, the new switch 1 transmits an update time request message 74A for making a request for the last update time of the configuration to the neighboring existing switch 2A, at a predetermined timing (for example, in a regular manner). In response to the last update time request message 74A from the new switch 1, the existing switch 2A returns an update time notification message 75A as the last update time of the configuration. In this case, both the update time notification messages 75A and 75B contain the update time 12:00.

When the administrator changes the filter setting of the existing switch to 18:00, the update time is stored in the update time storage area in the configuration 24 (6002).

After that, when the new switch 1 transmits an update time request message 74C to the existing switch 2A, the existing switch 2A returns an update time notification message 75C containing the update time 18:00.

Upon detection of a modification of the update time of the existing switch 2A, the new switch 1 transmits the configuration request message 71. Then, upon reception of the configuration notification message 72 from the existing switch 2A, the new switch 1 uses the updated filter setting contained in the configuration received from the existing switch 2A to update the filter setting.

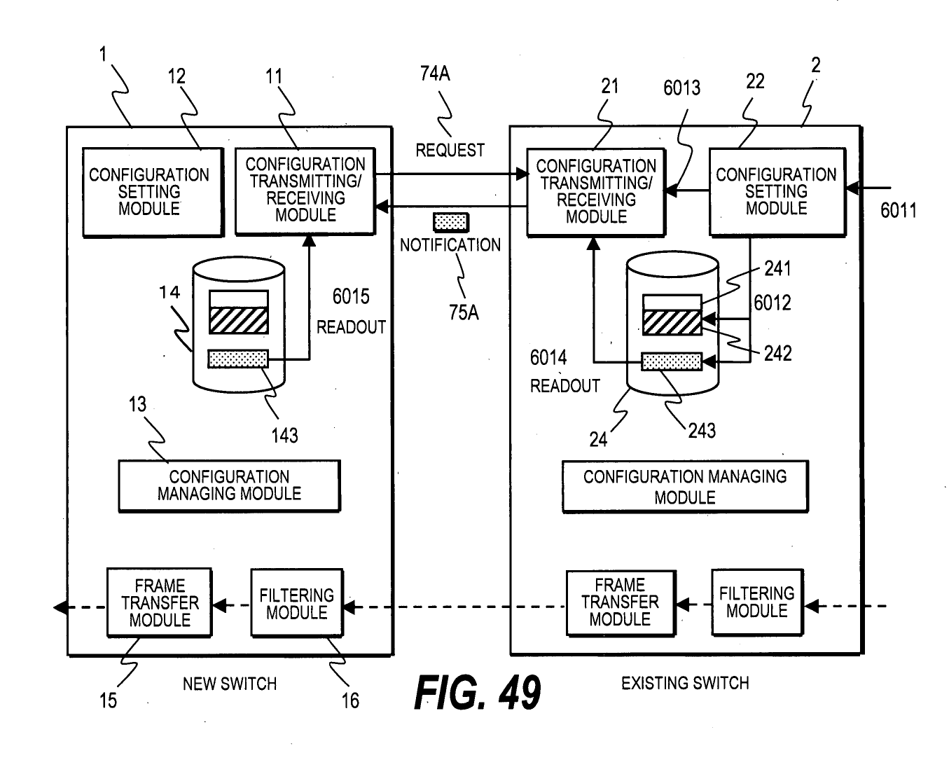

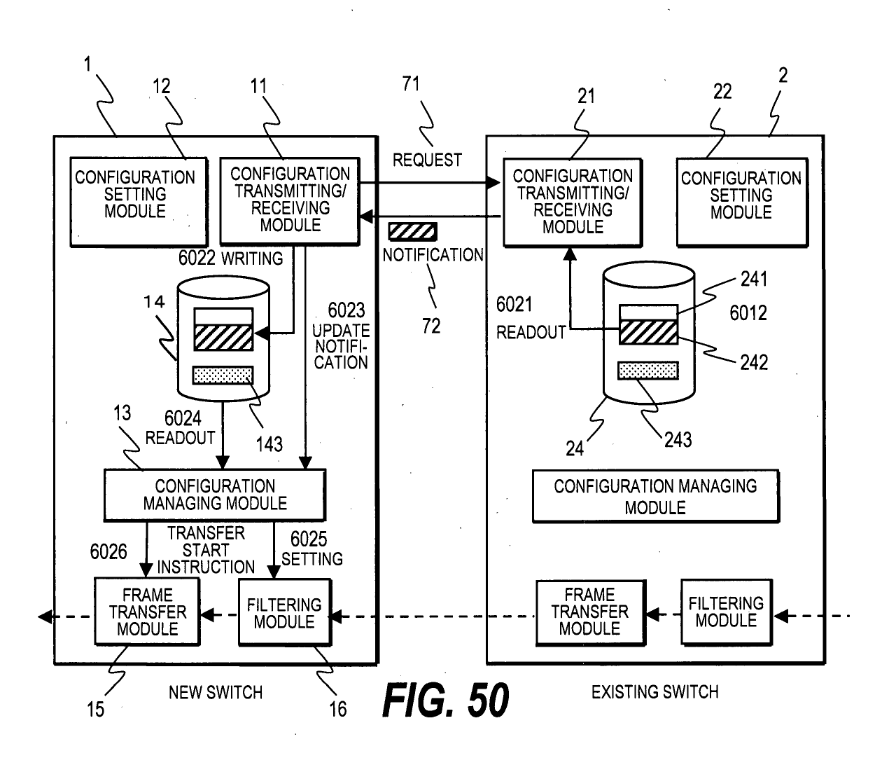

FIGS. 49 and 50 are explanatory views of the configuration synchronization processing according to the sixth embodiment, illustrating the communication of a message in the switch and between the switches when the new switch 1 confirms the update of the configuration with the existing switch 2A by polling.

The configuration 24 of the existing switch 2A according to the sixth embodiment is stored in a classified manner, specifically, as a part 242 whose content remains unchanged by the update, and a part 241 whose content has changed by the update.

The configuration 14 of the new switch 1 contains an update time storage area 143 that includes the last update time of the configuration. The update time storage area 143 can be updated by the configuration setting module 12 and the configuration transmitting/receiving module 11.

The configuration 24 of the existing switch 2 contains an update time storage area 243 that includes the last update time of the configuration. The update time storage area 243 can be updated by the configuration setting module 22 and the configuration transmitting/receiving module 21.

The administrator instructs a change of the filter setting through the input/output device 204 of the existing switch 2A (6011). In response to the instruction of changing the setting from the administrator, the configuration setting module 22 updates the configuration 24 and stores the update time in the update storage area 243 (6012). After that, the configuration setting module 22 notifies the configuration transmitting/receiving module 21 of the update of the configuration (6013).

At a predetermined timing, the configuration transmitting/receiving module 11 of the new switch 1 transmits the last update time request message 74A to the existing switch 2A.

Upon reception of the update time request message 74A from the configuration transmitting/receiving module 11, the configuration transmitting/receiving module 21 of the existing switch 2 reads out a last update time 243 from the configuration 24 (6014). Then, the configuration transmitting/receiving module 21 creates the update time notification message 75A that includes the readout last update time 243 and transmits the thus created update time notification message 75A to the configuration transmitting/receiving module 11.

Upon reception of the configuration update time notification message 75A, the configuration transmitting/receiving module 11 of the new switch 1 reads out the configuration update time 143 from the configuration 14 (6014). Then, the configuration transmitting/receiving module 11 compares the configuration update time of the existing switch 2A and that of the self apparatus to judge the precedence of the update of the configuration between the existing switch 2A and the self apparatus.

When the configuration of the existing switch 2A is updated after the update of the configuration of the self apparatus, the configuration transmitting/receiving module 11 transmits the configuration request message 71 to the existing switch 2A.

Upon reception of the notification of the configuration update, the configuration transmitting/receiving module 21 reads out the content of the updated part 242 of the configuration 24 and the update time (6021), and transmits the configuration notification message 72 that includes the content of the updated part 241 of the configuration. At this time, the last update time 243 of the configuration may be contained in the configuration notification message 72.

Upon reception of the configuration notification message 72 from the existing switch 2, the configuration transmitting/receiving module 11 of the new switch 1 extracts the configuration from the received message to update the configuration 14 of the self apparatus based on the content of the extracted configuration (6022). After that, the configuration transmitting/receiving module 11 notifies the configuration managing module 13 of the update of the configuration (6023).

Upon reception of the update notification of the configuration from the configuration transmitting/receiving module 11, the configuration managing module 13 reads out the configuration 14 in the self apparatus (6024) to apply the updated filter rule to the filtering module 16 (6025). After that, the configuration managing module 13 instructs the frame transfer module 15 to start the frame transfer (6026).

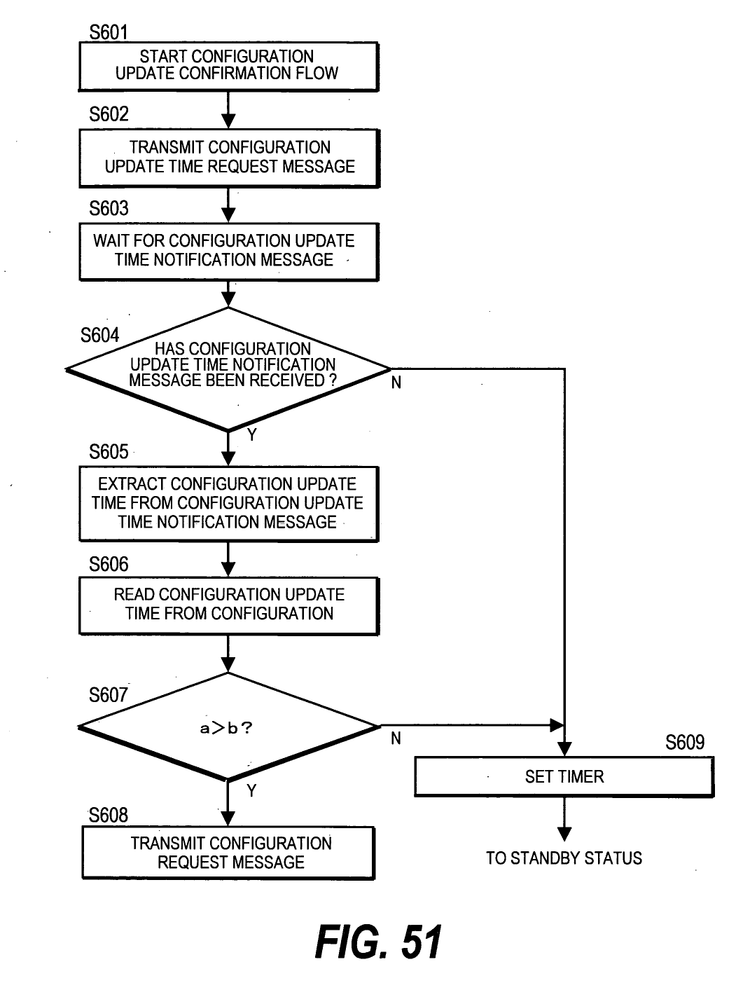

FIG. 51 is a flowchart of a configuration confirmation processing according to the sixth embodiment, the processing being executed in the configuration transmitting/receiving module 11 on the new switch 1 side when the new switch 1 confirms the update of the configuration by polling.

At a predetermined timing, the configuration transmitting/receiving module 11 executes a configuration update confirmation processing (S601).

First, the configuration transmitting/receiving module 11 transmits the last update time request message 74A to the neighboring existing switch 2A (S602). After that, the configuration transmitting/receiving module 11 waits for the configuration update time notification message 75A (S603).

Then, upon reception of the configuration update time notification message 75A (S604), the configuration transmitting/receiving module 11 extracts the last update time of the configuration in the existing switch 2A from the received configuration update time notification message 75A (S605). Moreover, the configuration transmitting/receiving module 11 reads out the configuration update time from the configuration 14 of the self apparatus (S606).

Then, the configuration transmitting/receiving module 11 compares the configuration update time of the existing switch 2A and that of the self apparatus with each other (S607). As a result, when the configuration update time of the existing switch 2A is later than that of the self apparatus, the configuration transmitting/receiving module 11 transmits the configuration request message 71 to the existing switch 2A (S608) to synchronize the configuration 14 of the new switch 1 with the configuration 24 of the existing switch 2A.

On the other hand, when no response has been sent from the existing switch 2 even when a predetermined time has elapsed after the transmission of the configuration update time request message 74A, the configuration transmitting/receiving module 11 sets a timer (S609) to return to the standby status. Based on the timer, the configuration transmitting/receiving module 11 executes the configuration update confirmation processing (FIG. 51) again after elapse of a predetermined time.

Even when the update time contained in the configuration update time notification message 75A from the existing switch 2A is the same as or earlier than the update time included in the configuration of the self apparatus, the configuration transmitting/receiving module 11 sets the timer (S609) to return to the standby status.

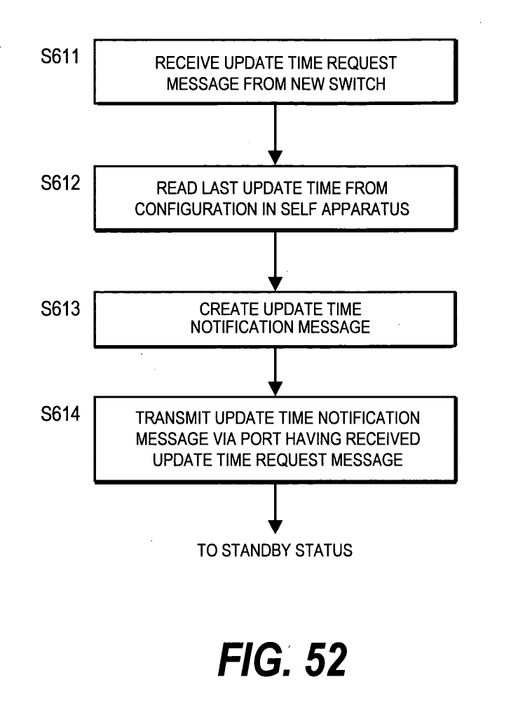

FIG. 52 is a flowchart of the configuration confirmation processing according to the sixth embodiment, the processing being executed in the configuration transmitting/receiving module 21 on the existing switch 2A side when the new switch 1 confirms the update of the configuration by polling.

Upon reception of the update time request message 74A from the new switch 1 (S611), the configuration transmitting/receiving module 21 reads out the last update time from the configuration 24. Then, the configuration transmitting/receiving module 21 creates the update time notification message 75A that includes the readout last update time (S613). Then, the configuration transmitting/receiving module 21 transmits the update time notification message 75A via the port that has received the update time request message 74A from the new switch 1 (S614).

The configuration transmitting/receiving module 21 of the existing switch 2A according to the sixth embodiment operates in the same manner as in the configuration transmission processing (FIG. 19) according to the first embodiment. To be specific, upon reception of the configuration request message 71, the configuration transmitting/receiving module 21 reads out the configuration 24 (S141), creates the configuration notification message 72 containing the readout configuration (S142), and transmits the configuration notification message 72 (S143).

Moreover, the configuration transmitting/receiving module 11 of the new switch 1 operates in the same manner as in the configuration synchronization processing (FIG. 28) according to the third embodiment. To be specific, upon reception of the configuration notification message 72, the configuration transmitting/receiving module 11 extracts the configuration from the message (S311), updates the configuration 14 (S312), and notifies the configuration managing module 13 of the update of the configuration (S313).

Furthermore, the configuration managing module 13 of the new switch 1 operates in the same manner as in the configuration update processing (FIG. 17) according to the first embodiment. To be specific, upon reception of the configuration update notification from the configuration transmitting/receiving module 11, the configuration managing module 13 reads out the configuration 14 (S131), sets the updated filter rule to the filtering module (S133), and instructs the frame transfer module 15 to start the frame transfer.

As described above, in the sixth embodiment, the new switch 1 that has received the configuration from the existing switch 2A regularly confirms the update of the configuration in the existing switch 2A, detects the update of the configuration based on a change of the update time of the existing switch 2A, and makes a request for the configuration. Therefore, the existing switch 2A is not required to retain the configuration notification history for each port. The existing switch 2A notifies only the port, to which the switch that is required to be notified of the configuration is connected, of the content of the update of the configuration according to the response from the new switch 1.

### Seventh Embodiment

In a seventh embodiment of this invention, for obtaining the configuration from the existing switch 2 to which the new switch 1 is connected, the new switch 1 also obtains information regarding locations of various management servers connected to the network 5.

In the seventh embodiment, since the switch configuration is the same as that of the first embodiment described above except for differences described below, the same components are denoted by the same reference numerals and the description thereof is herein omitted.

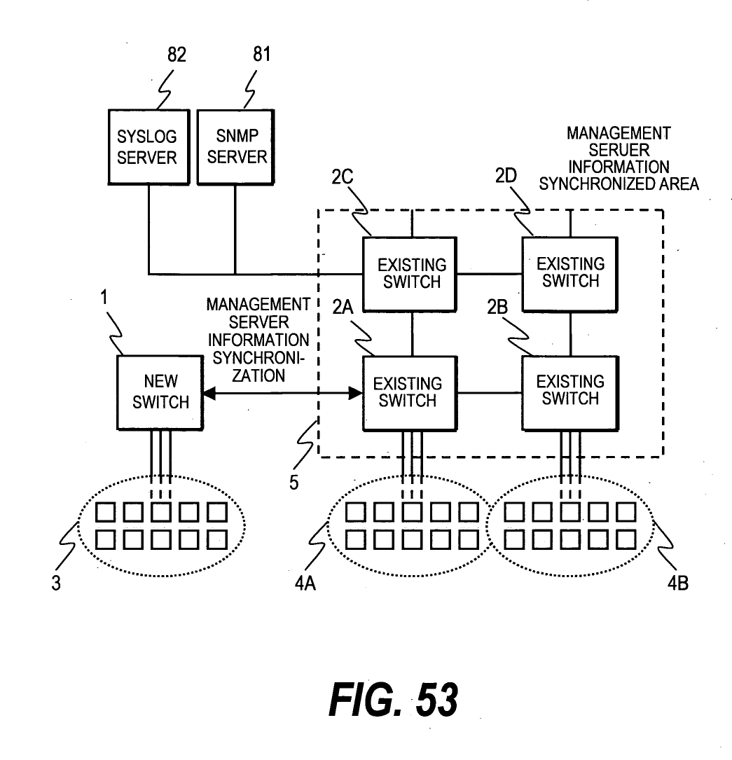

FIG. 53 is a configuration view of the network including the switches according to the seventh embodiment.

The existing network 5 includes the switches 2A to 2D, each transmitting a frame in the network.

A filter rule is set in each of the switches 2A to 2D. Based on the set filter rule, frames and packets are selected to discard unnecessary frames and packets. In this manner, policy that ensures the network security is operated.

The existing terminal groups 4A and 4B are connected to the switches 2A to 2D. The terminal group 3, which is newly installed, is connected to the switch 1.

In the seventh embodiment, the case where the switch 1 which connects the added computers (the terminal group 3) to the network is newly installed will be considered. In this case, the switch 1 is connected to the existing switch 2A to obtain the filter setting from the switch 2A, thereby reflecting the obtained filter setting on the self apparatus.

Management servers 81 and 82 are connected to an existing switch 2C in a communicable manner. In this embodiment, an SNMP server 81 and a syslog server 82 are provided as the management servers.

The SNMP server 81 monitors equipment (switches 1 and 2A to 2D) connected to the network via the network to manage an operating status of the equipment and a status of traffic. The syslog server 82 collects logs output from the equipment connected to the network via the network to manage the collected logs in a collective manner. In order that the new switch 1 is monitored by the servers for its operating status and the logs of the switch 1 are collected, addresses or host names of the servers are required to be set in the configuration of the new switch 1 as a status notification request source and a log transmission destination.

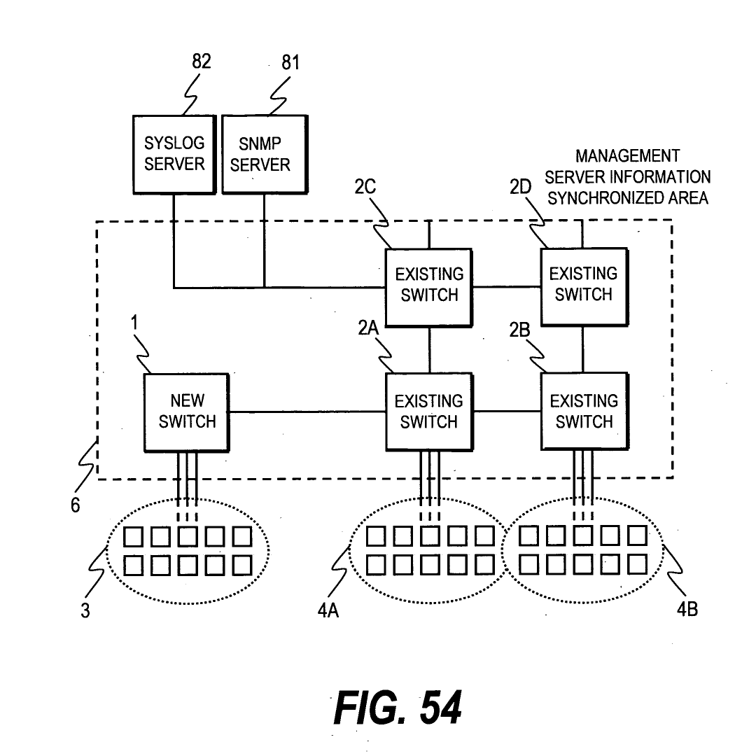

FIG. 54 is a configuration diagram of the network including the switches according to the seventh embodiment, illustrating a status where the settings of the configuration and the locations of the management servers are completed for the switch 1.

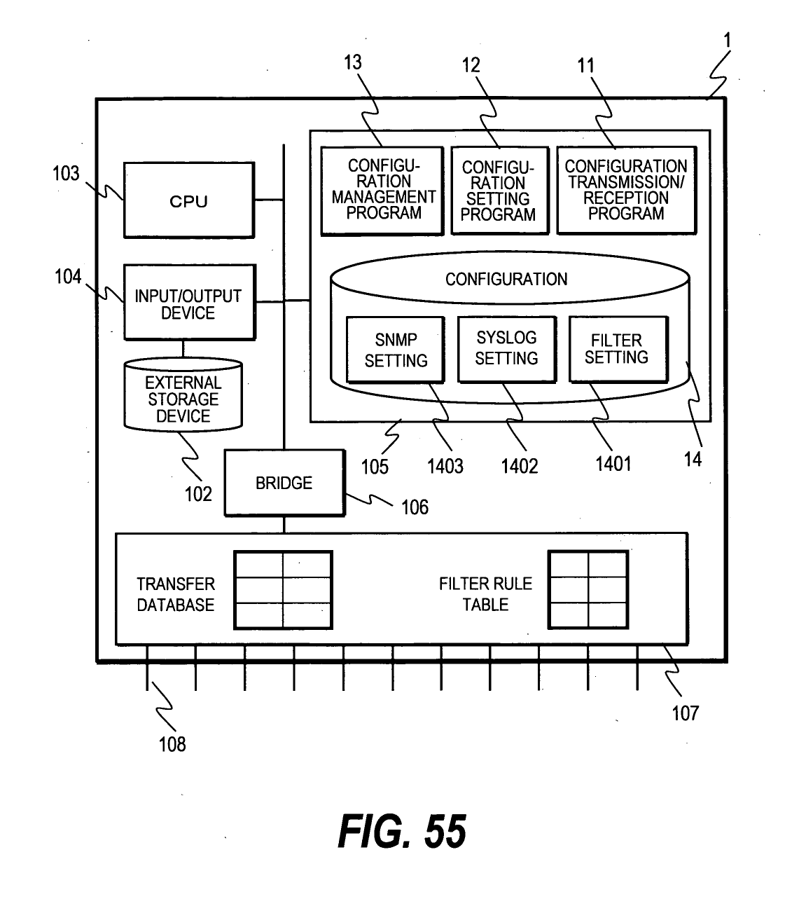

FIG. 55 is a block diagram of the switch according to the seventh embodiment. The switch according to the seventh embodiment includes a filter setting 1401, a syslog setting 1402, and an SNMP setting 1403 in the configuration 14.

According to the above-described embodiment, when the configuration is synchronized between the new switch 1 and the existing switch 2A, the new switch 1 obtains information of the addresses or the host names of the management servers 81 and 82 from the existing switch 2A. Then, the existing switch 1 sets the addresses or the host names of the management servers 81 and 82 obtained from the existing switch 2A to start communication with the management servers 81 and 82.

As a result, at the time of introduction of the new switch 1 to the network, the new switch 1 can automatically be set as a target of monitoring and log collection by the management servers 81 and 82 without setting the addresses or the host names of the management servers 81 and 82 by the administrator. The automation of the setting of the monitoring and the log collection at the time of introduction of the new switch 1 to the network helps the administrator grasp the network configuration to ensure that all networking equipment be managed for operation.

Besides, the seventh embodiment can also be applied to address setting of other types of servers (for example, an NTP server or a RADIUS authentication server).

### Eighth Embodiment

In an eighth embodiment of this invention, a layer-2 switch 84 is provided between the new switch 1 and the existing switch 2A.

In the eighth embodiment, since the switch configuration is the same as that of the first embodiment described above except for differences described below, the same components are denoted by the same reference numerals and the description thereof is herein omitted.

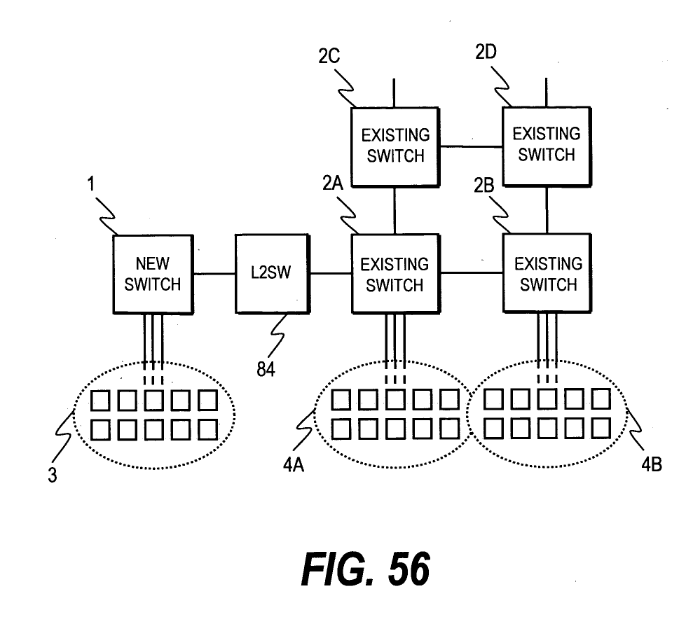

FIG. 56 is a configuration view of the network including the switches according to the eighth embodiment.

The eighth embodiment network includes the switches 2A to 2D, each transmitting a frame in the network.

A filter rule is set in each of the switches 2A to 2D. Based on the set filter rule, frames and packets are selected to discard unnecessary frames and packets. In this manner, policy that ensures the network security is operated.

Already installed terminal groups 4A and 4B are connected to the switches 2A to 2D.

The new switch 1 is connected to the existing switch 2A through the layer-2 switch 84. Upon activation, the new switch 1 transmits the configuration request message 71 to the layer-2 switch 84 through its own designated port or the active port. At this time, a broadcast address is includes as a destination MAC address in the header 711 of the configuration request message 71. Since the destination of the configuration request message 71 transmitted from the new switch 1 is a broadcast address, the layer-2 switch 84 transmits the configuration request message 71 to all the ports. Thus, the configuration request message 71 is transmitted to the existing switch 2A through the layer-2 switch 84.

The configuration transmitting/receiving module 21 of the existing switch 2A according to the eighth embodiment operates in the same manner as in the configuration transmission processing (FIG. 19) according to the first embodiment. To be specific, upon reception of the configuration request message 71 from the new switch 1 through the layer-2 switch, the configuration transmitting/receiving module 21 reads out the configuration 24 (S141), creates the configuration notification message 72 containing the readout configuration (S142), and transmits the configuration message 72 (S143).

At this time, the MAC address, designated by the new switch 1 as a transmission source MAC address of the header 711 of the configuration request message 71, is includes as the destination MAC address in the header 711 of the configuration notification message 72. Since the existing switch 2A has obtained the MAC address upon reception of the configuration request message 71 from the new switch 1, the existing switch 2A transmits the configuration notification message 72 to the layer-2 switch 84. Since the layer-2 switch 84 obtains the MAC address of the new switch 1 in the same manner, the layer-2 switch 84 transfers the configuration notification message 72 through the port to which the new switch 1 is connected.

The configuration managing module 13 of the new switch 1 operates in the same manner as in the configuration update processing (FIG. 17) according to the first embodiment. To be specific, upon reception of the update notification of the configuration from the configuration transmitting/receiving module, the configuration managing module 13 reads out the configuration 14 (S131), sets the updated filter rule to the filtering module (S133), and instructs the frame transfer module to start the frame transfer (S135).

By the above-described operation, the new switch 1, which is connected to the existing switch 2A through the layer-2 switch 84, can synchronize the filter rule with the network constituted by the switches 2A to 2D. As a result, at the time of expansion of the network, the transmission of an attack frame to the terminal group 3 or the transmission of an unauthorized frame from the terminal group 3 can be prevented without requiring the administrator to set the filter rule to the new switch 1.

It is suitable to apply this invention to a middle-scale router or switch for a corporate network and to a wireless LAN access point.

While the present invention has been described in detail and pictorially in the accompanying drawings, the present invention is not limited to such detail but covers various obvious modifications and equivalent arrangements, which fall within the purview of the appended claims.

What is claimed is:

1. A packet transmitting apparatus included in a network, for transferring a frame in the network, comprising:
a storage unit for storing a configuration of this apparatus;
a memory for storing a control program;
a processor for executing the control program stored in the memory;
an interface including a plurality of ports;
a switch connected to the interface;
a configuration managing module implemented by the control program executed by the processor, for setting a frame transfer function and a filter function based on the configuration;
a configuration setting module implemented by the control program executed by the processor, for providing an interface that accepts an instruction regarding the configuration for an administrator; and
a configuration transmitting/receiving module implemented by the control program executed by the processor, for transmitting and receiving the configuration to/from another packet transmitting apparatus; wherein:
the switch filters a frame to be transferred based on a set filtering condition;
the configuration transmitting/receiving module makes a request for a configuration to the another packet transmitting apparatus included in the network, receives the configuration from the another packet transmitting apparatus, updates the configuration of this apparatus based on the received configuration, and notifies the configuration managing module of the update of the configuration; and
the configuration managing module obtains, upon reception of the notification of the update of the configuration from the configuration transmitting/receiving module, the updated configuration from the storage unit, and sets the filtering condition based on the obtained configuration.

2. The packet transmitting apparatus according to claim 1, wherein the configuration transmitting/receiving module receives, upon activation of the packet transmitting apparatus, the configuration from the another packet transmitting apparatus in operation in the network and sets the received configuration as the configuration of this apparatus.

3. The packet transmitting apparatus according to claim 1, wherein the configuration transmitting/receiving module transmits a request for the configuration from a port designated by the administrator.

4. The packet transmitting apparatus according to claim 1, wherein the configuration transmitting/receiving module searches an active port and transmits a request for the configuration from the searched port.

5. The packet transmitting apparatus according to claim 1, wherein the configuration transmitting/receiving module obtains, upon activation of the packet transmitting apparatus, the configuration from the storage unit, judges whether the obtained configuration includes an acquisition instruction of the configuration from the another packet transmitting apparatus in operation in the network, and makes a request for the configuration to the another packet transmitting apparatus according to the acquisition instruction when the configuration includes the configuration acquisition instruction.

6. The packet transmitting apparatus according to claim 1, wherein the configuration setting module instructs, upon reception of an instruction of synchronizing the configuration from the administrator, the configuration transmitting/receiving module to synchronize the configuration; and
the configuration transmitting/receiving module makes a request for the configuration to the another packet transmitting apparatus upon reception of the instruction of synchronizing the configuration from the configuration setting module.

7. The packet transmitting apparatus according to claim 1, wherein the configuration transmitting/receiving module transmits a request for the configuration from a port when a status of the port becomes active.

8. The packet transmitting apparatus according to claim 1, wherein:
the storage unit stores synchronization status information including a synchronization status of the configuration through the port and a status of the another packet transmitting apparatus connected to the port; and
the configuration transmitting/receiving module notifies of the synchronization status of the configuration from the port that changes active status when a status of the port becomes active, receives a notification of the synchronization status of the configuration as a response to the notification which is sent from the another packet transmitting apparatus connected to the port that changes active status, and makes a request for the configuration to the another packet transmitting apparatus when it is judged that the configuration of the another packet transmitting apparatus has already been set based on the received synchronization status.

9. The packet transmitting apparatus according to claim 1, wherein:
the storage unit stores an update time of the configuration of this apparatus; and
the configuration transmitting/receiving module periodically makes a request for the update time to the another packet transmitting apparatus from the port which has received the configuration, receives a notification of the update time from the another packet transmitting apparatus, compares the received update time of the another packet transmitting apparatus and the stored update time of the configuration of this apparatus with each other, and makes a request for the configuration to the another packet transmitting apparatus when the update time of the another transmitting apparatus is later than that of this apparatus.

10. A packet transmitting apparatus included in a network, for transferring a frame in the network, comprising:
a storage unit for storing a configuration of this apparatus;
a memory for storing a control program;
a processor for executing the control program stored in the memory;
an interface including a plurality of ports;
a switch connected to the interface;
a configuration managing module implemented by the control program executed by the processor, for setting a frame transfer function and a filter function based on the configuration;
a configuration setting module implemented by the control program executed by the processor, for providing an interface that accepts an instruction regarding the configuration for an administrator; and
a configuration transmitting/receiving module implemented by the control program executed by the processor, for transmitting and receiving the configuration to/from another packet transmitting apparatus; wherein:
the switch filters a frame to be transferred based on a set filtering condition; and
the configuration transmitting/receiving module transfers the configuration set in this apparatus to the another packet apparatus included in the network.

11. The packet transmitting apparatus according to claim 10, wherein the configuration transmitting/receiving module transmits setting of the filtering condition included with the configuration.

12. The packet transmitting apparatus according to claim 10, wherein the configuration transmitting/receiving module transmits information of an address of a management server connected to the network included with the configuration.

13. The packet transmitting apparatus according to claim 10, wherein the configuration transmitting/receiving module transmits a notification of the configuration from a port designated by the administrator.

14. The packet transmitting apparatus according to claim 10, wherein the configuration transmitting/receiving module searches an active port and transmits a notification of the configuration from the searched port.

15. The packet transmitting apparatus according to claim 10, wherein: the configuration setting module instructs, upon reception of an instruction of synchronizing the configuration from the administrator, the configuration transmitting/receiving module to synchronize the configuration; and
the configuration transmitting/receiving module notifies the another packet transmitting apparatus included in the network of the configuration upon reception of the instruction of synchronizing the configuration from the configuration setting module.

16. The packet transmitting apparatus according to claim 10, wherein:
the configuration setting module notifies, upon change of the configuration of this apparatus, the configuration transmitting/receiving module of the update of the configuration; and
the configuration transmitting/receiving module transmits, upon reception of the notification of the update of the configuration from the configuration setting module, the updated configuration to the another packet transmitting apparatus included in the network.

17. The packet transmitting apparatus according to claim 10, wherein:
the storage unit stores a notification history of the configuration through the port; and
the configuration transmitting/receiving module transmits the configuration from a port indicated by the notification history.

18. The packet transmitting apparatus according to claim 1, wherein the configuration transmitting/receiving module communicates with the another packet transmitting apparatus included in the network through message exchange on a data link.

19. The packet transmitting apparatus according to claim 1, wherein the configuration transmitting/receiving module communicates with the another packet transmitting apparatus included in the network by a broadcast frame transmitted on a layer-2 network.

20. The packet transmitting apparatus according to claim 1, wherein the configuration transmitting/receiving module communicates with the another packet transmitting apparatus included in the network by message transmitting through a management server included in the network.
